(19) United States
(12) Patent Application Publication
(10) Pub. No.: US 2011/0182156 A1
(43) Pub. Date: Jul. 28, 2011

(54) OPTICAL DISC RECORDING METHOD, OPTICAL DISC RECORDING DEVICE CONTROL METHOD, OPTICAL DISC RECORDING DEVICE, HOST DEVICE, OPTICAL DISC RECORDING CONTROL PROGRAM, AND OPTICAL DISC RECORDING DEVICE CONTROL PROGRAM

(75) Inventors: KEISUKE SASAKI, OSAKA (JP); HIROMICHI SHIMADA, HYOGO (JP); HIROYUKI YABUNO, OSAKA (JP)

(73) Assignee: PANASONIC CORPORATION, OSAKA (JP)

(21) Appl. No.: 13/081,130

(22) Filed: Apr. 6, 2011

Related U.S. Application Data
(63) Continuation of application No. PCT/JP2009/002638, filed on Jun. 11, 2009.

(30) Foreign Application Priority Data
Oct. 8, 2008 (JP) 2008-262023

(51) Int. Cl. G11B 20/12; G11B 7/0045; G11B 20/10

(52) U.S. Cl. 369/30.37; 369/53.31; 369/53.2; G9B/20.015; G9B/7.01; G9B/20.009

(57) ABSTRACT

Optical disc recording processing of recording data to be recorded on an optical disc having a plurality of recording layers at a recording velocity depending on the radial position includes use pattern selection processing of selecting a use pattern in which given recordable regions included in a data zone of the optical disc are used for recording of the data to be recorded in given use order, among a plurality of use patterns different in the number of recording layers used, so that the total recording time is shortened, based on given conditions including at least the capacity of the data to be recorded, the recording velocities of use regions in the use pattern, and the number of interlayer shifts in the use pattern. The data to be recorded is recorded according to the use pattern selected in the use pattern selection processing.

### CROSS-REFERENCE TO RELATED APPLICATION

This is a continuation of PCT International Application PCT/JP2009/002638 filed on Jun. 11, 2009, which claims priority to Japanese Patent Application No. 2008-262023 filed on Oct. 8, 2008. The disclosures of these applications including the specifications, the drawings, and the claims are hereby incorporated by reference in their entirety.

### BACKGROUND

The present disclosure relates to an optical disc recording method and device for recording data on an optical disc such as BD-R and BD-RE and an optical disc recording device control method and a host device for controlling such an optical disc recording device, and more particularly to a technique of allocating data to be recorded to an optical disc.

In Japanese Patent Publication No. 2004-134022 (Patent Document 1), the recording start address is computed so that the recording end position of data to be recorded is at the outermost periphery of a data zone, and recording of the data is started at the computed recording start address, thereby to allow the recorded data to be reproduced at high speed.

Japanese Patent Publication No. 2006-155714 (Patent Document 2) discloses a disc recording/reproduction device, which, if failing in recording on an inner portion of a high-speed recording-capable optical disc at a specified linear velocity due to limitations on the torque and number of revolutions of the spindle motor, performs recording on only a portion of the data zone closer to the outermost periphery than a given position.

### SUMMARY

In Patent Document 1, in which the data zone is used for recording starting from its outer portion preferentially, the actual recording time required to record data is shortened compared with the case of recording data on the optical disc from inner to outer portions sequentially.

However, in recording of data on an optical disc having a plurality of recording layers, although the actual recording time can be shortened by the preferential use of an outer portion of the data zone, the time required for change of the focus position, recording calibration, etc. will become long, resulting in increase in total recording time in some cases.

In Patent Document 2, in which data is recorded in only a region of the data zone closer to the outermost periphery than a given data recording start position, the actual recording time can be shortened compared with the case of using an inner region. However, the time required for change of the focus position, recording calibration, etc. will become long, resulting in increase in total recording time in some cases.

It is an objective of the present disclosure to shorten the total recording time required to record data on an optical disc.

The first embodiment of the present disclosure is directed to optical disc recording processing of recording data to be recorded on an optical disc having a plurality of recording layers at a recording velocity depending on a radial position, the processing including use pattern selection processing of selecting a use pattern in which given recordable regions included in a data zone of the optical disc are used for recording of the data to be recorded in given use order, among a plurality of use patterns different in the number of recording layers used, so that the total recording time is shortened, based on given conditions including at least the capacity of the data to be recorded, the recording velocities of use regions in the use pattern, and the number of interlayer shifts in the use pattern, wherein the data to be recorded is recorded according to the use pattern selected in the use pattern selection processing.

In the first embodiment described above, the data to be recorded is recorded according to a use pattern selected so that the total recording time required for recording of the data to be recorded is shortened. Therefore, the total recording time can be shortened.

The second embodiment of the present disclosure is directed to optical disc recording processing of recording data to be recorded on an optical disc having at least one recording layer, the processing including: region division processing of dividing a data zone of each recording layer of the optical disc in a radial direction to determine a plurality of divided regions; and priority determination processing of determining a priority of each of the divided regions determined in the region division processing based on a characteristic of the divided region, wherein the divided regions are used for recording of the data to be recorded in decreasing order of the priority determined in the priority determination processing.

In the second embodiment described above, divided regions are used for recording of the data to be recorded in decreasing order of the priority determined based on a characteristic of each divided region. Therefore, by giving a high priority to a divided region high in linear velocity, for example, it is possible to perform recording faster.

The third embodiment of the present disclosure is directed to optical disc recording device control processing executed by a host device that transmits data to be recorded, of which recording instruction has been given by the user, to an optical disc recording device, the processing including: capacity determination processing of determining the capacity of the data to be recorded; and capacity notification processing of notifying the optical disc recording device of the capacity of the data to be recorded determined in the capacity determination processing.

In the third embodiment described above, the optical disc recording device notified of the capacity of the data to be recorded can determine a use region for the data to be recorded based on the notified capacity of the data to be recorded.

The fourth embodiment of the present disclosure is directed to optical disc recording device control processing executed by a host device that transmits data to be recorded, of which recording instruction has been given by the user, to an optical disc recording device that records data on part or the entire of an optical disc in a CAV control mode, the processing including: recordable region determination processing of determining a recordable region in a data zone of the optical disc based on information read from the optical disc by the optical disc recording device; and use region determination processing of determining a region including no innermost periphery, as a use region, from the recordable region determined in the recordable region determination processing, wherein the host device instructs the optical disc recording device to record the data to be recorded in the use region determined in the use region determination processing.

In the fourth embodiment described above, an innermost portion of the optical disc low in linear velocity is not used for recording of the data to be recorded. Therefore, faster recording is performed, and this can shorten the recording time.

The fifth embodiment of the present disclosure is directed to optical disc recording device control processing executed by a host device that instructs an optical disc recording device to reproduce data in response to an instruction from the user, the processing including linkage information reception processing of receiving data linkage information indicating reproduction order of divided regions from the optical disc recording device when the data to be reproduced has been divided and recorded in a plurality of divided regions, wherein the host device instructs the optical disc recording device to reproduce the data in the plurality of divided regions in the reproduction order indicated by the data linkage information received in the linkage information reception processing.

In the fifth embodiment described above, it is possible to allow an optical disc recording device, which has no function of reproducing data in a plurality of divided regions in reproduction order indicated by data linkage information, to reproduce data in the plurality of divided regions in the reproduction order indicated by the data linkage information.

### BRIEF DESCRIPTION OF THE DRAWINGS

FIG. 1 is a block diagram of an optical disc recording system of the first embodiment of the present invention.

FIG. 2 is a block diagram of an optical disc recording/reproduction device 100 in the first embodiment.

FIG. 3 is a view illustrating an example of a use pattern selected by data recording region allocation processing in the first embodiment.

FIG. 4 is a block diagram of a host device 120 in the first embodiment.

FIG. 5 is a view illustrating logical address space of a data zone of an optical disc 101 in the first embodiment.

FIG. 6 is a flowchart showing an operation of the optical disc recording system of the first embodiment.

FIG. 7 is a flowchart showing an operation of the host device 120 in (S1004) in FIG. 6 in the first embodiment.

FIG. 8 is a flowchart showing an operation of the optical disc recording/reproduction device 100 in (S1004) in FIG. 6 in the first embodiment.

FIG. 9 is a flowchart showing an operation of the optical disc recording/reproduction device 100 in (S1201) in FIG. 8 in the first embodiment.

FIG. 10 is an example graph showing the relationship between the radial position of recordable regions on layers L0, L1, and L2 of the optical disc 101 and the linear velocity in the first embodiment.

FIG. 11 is a flowchart showing an operation of the optical disc recording/reproduction device 100 in (S1207) in FIG. 8 in the first embodiment.

FIG. 12 is a flowchart showing an operation of the optical disc recording system in (S1005) in FIG. 6 in the first embodiment.

FIG. 13 is a view illustrating a conventional method of recording data to be recorded on an optical disc.

FIG. 14 is a view illustrating an example of a use pattern selected by the data recording region allocation processing in the case of addition of data to be recorded in the first embodiment.

FIG. 15 is a block diagram of an optical disc recording system 200 of the second embodiment of the present invention.

FIG. 16 is a view illustrating divided zones of an optical disc in a ZCLV control mode in the second embodiment.

FIG. 17 is a view illustrating an example of use regions and use order determined when data to be recorded is recorded on the optical disc 101 in its non-recorded state in the second embodiment.

FIG. 18 is a view illustrating an example of use regions and use order determined when data to be recorded is additionally recorded on the optical disc 101 in the second embodiment.

FIG. 19 is a view illustrating another example of use regions and use order determined when data to be recorded is additionally recorded on the optical disc 101 in the second embodiment.

FIG. 20 is a flowchart corresponding to that of FIG. 9 in the second embodiment.

FIG. 21 is a flowchart corresponding to that of FIG. 9 in the third embodiment.

FIG. 22 is a view illustrating an example of divided regions determined in (S3211) in the third embodiment.

FIG. 23 is a view illustrating an example of use order determined in (S3212) when data to be recorded is recorded on the optical disc 101 in its non-recorded state in the third embodiment.

FIG. 24 is a view illustrating an example of use order determined in (S3212) when data to be recorded is additionally recorded on the optical disc 101 in the third embodiment.

FIG. 25 is a view illustrating divided regions determined in (S3211) in a variation of the third embodiment.

FIG. 26 is a view illustrating division of a given region A in the data zone into divided regions 1 and 2 in the variation of the third embodiment.

FIG. 27 is a block diagram of a host device 420 in the fourth embodiment of the present invention.

FIG. 28 is a flowchart showing an operation of the host device 420 in (S1004) in FIG. 6 in the fourth embodiment.

FIG. 29A is a view illustrating an example of a use region and use priorities of divided regions used when data to be recorded is recorded on the optical disc 101 in its non-recorded state. FIG. 29B is a view illustrating an example of a use region and use priorities of divided regions used when data to be recorded is additionally recorded on the optical disc 101.

### DETAILED DESCRIPTION

Embodiments of the present invention will be described hereinafter with reference to the drawings. Note that, in the following embodiments, components having similar functions are denoted by the same reference characters, and description on such components will not be repeated.

### First Embodiment

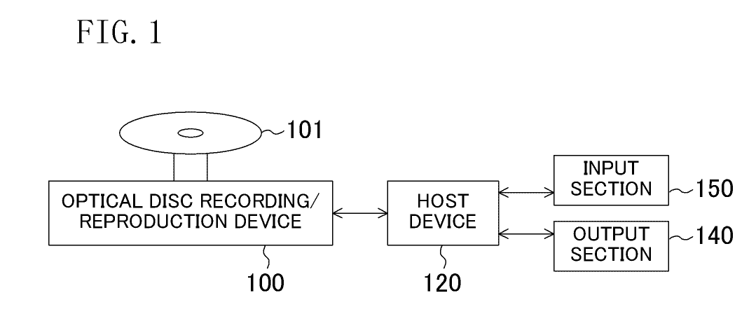

As shown in FIG. 1, an optical disc recording system of the first embodiment of the present invention includes: an optical disc recording/reproduction device 100 that records/reproduces data on/from an optical disc 101; a host device 120; an output section 140 that outputs the results of data processing by the host device 120; and an input section 150 used for data input into the host device 120 by the user.

<Configuration of Optical Disc Recording/Reproduction Device 100>

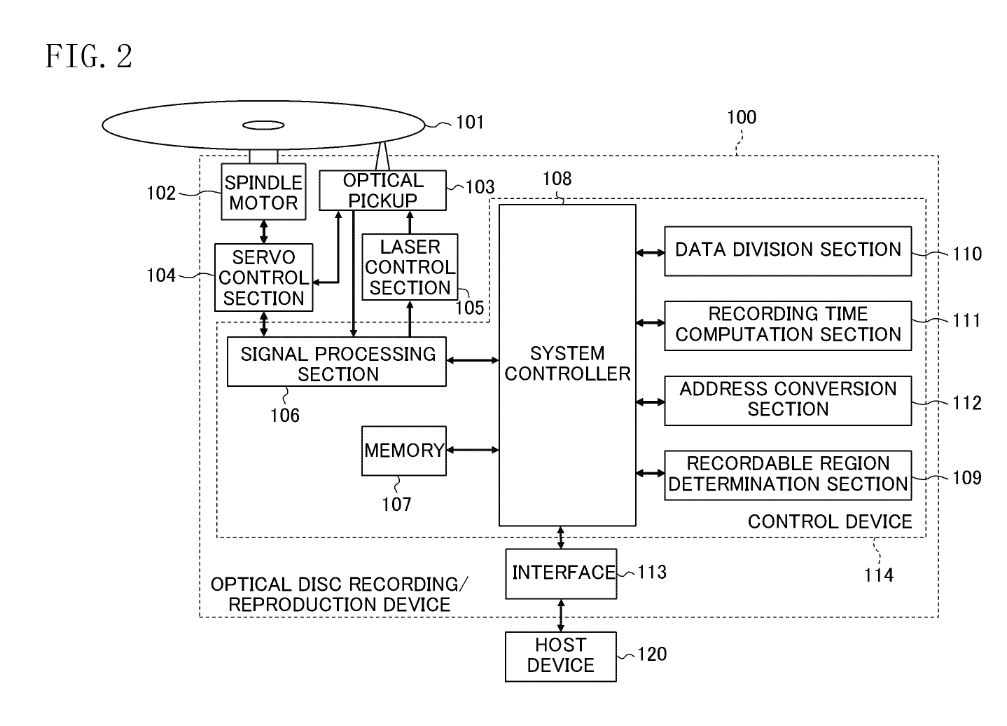

As shown in FIG. 2, the optical disc recording/reproduction device 100 includes a spindle motor 102, an optical pickup 103, a servo control section 104, a laser control section 105, a signal processing section 106, a memory 107, a system controller 108, a recordable region determination section 109, a data division section 110, a recording time computation section (use pattern selection section) 111, an address conversion section 112, and an interface 113. The signal processing section 106, the memory 107, the system controller 108, the recordable region determination section 109, the data division section 110, the recording time computation section 111, and the address conversion section 112 constitute a control device 114 that controls the optical pickup 103 indirectly. The control device 114 executes a program recorded in an information recording medium such as an optical disc, a magnetic disc, and a nonvolatile semiconductor memory (including any type of read-only memory (ROM)), thereby to implement functions of the optical disc recording/reproduction device 100. The control device 114 may otherwise execute the program recorded in the information recording medium after loading the program into a volatile semiconductor memory such as a random access memory (RAM).

The spindle motor 102 rotates the optical disc 101.

The optical pickup 103 includes: a laser diode (LD) that emits laser light; a reflected light photodetector that detects light reflected from the optical disc; a forward light photodetector that receives the laser light itself output by the LD (both photodetectors are collectively called light receiving elements); and an objective lens through which the laser light emitted by the LD passes. The optical pickup 103 outputs a reflected light signal indicating the intensity of the reflected light detected by the reflected light photodetector and a laser light signal indicating the intensity of the laser light itself received by the forward light photodetector.

The servo control section 104 controls the rotation of the spindle motor 102, and also controls tracking and focusing of the optical pickup 103.

The laser control section 105 controls the intensity of the laser output of the optical pickup 103.

The signal processing section 106 processes a signal received from the servo control section 104 to generate signals for control of tracking, focusing, and the number of revolutions of the spindle motor, and feeds back the generated signals to the servo control section 104. Also, the signal processing section 106 receives the laser light signal output from the optical pickup 103, and feeds back a signal for laser control to the laser control section 105. Moreover, the signal processing section 106 receives the reflected light signal output from the optical pickup 103, and outputs a reproduction signal based on the reflected light signal to the system controller 108.

The memory 107 stores data according to instructions from the system controller 108 or according to instructions from any of the blocks via the system controller 108.

The system controller 108 controls the blocks of the optical disc recording/reproduction device 100.

The recordable region determination section 109 receives optical disc management information stored in the memory 107 via the system controller 108, and determines recordable regions in a data zone of the optical disc 101 based on the optical disc management information. The optical disc management information as used herein refers to information indicating whether or not recorded data already exists on the loaded optical disc 101, i.e., whether the optical disc 101 is already-recorded or non-recorded, and the recorded position (e.g., start address), size (capacity), format, etc. of recorded data if any. The recordable region determination section 109 instructs the memory 107 to store information indicating the determined recordable regions (hereinafter, referred to as “recordable region determination information”) via the system controller 108.

The data division section 110 receives the recordable region determination information stored by the recordable region determination section 109 from the memory 107 via the system controller 108. Based on the recordable regions indicated by the received recordable region determination information and the capacity of data to be recorded under an instruction of recording on the optical disc 101 (data to be recorded), the data division section 110 divides the data to be recorded so that the data can be recorded in the recordable regions.

The recording time computation section 111 derives the total recording time for each of a plurality of use patterns, in which given recordable regions are used for recording of the data to be recorded in given use order, based on the linear velocities (recording velocities) of the recordable regions of the optical disc 101, the capacity of the data to be recorded, the number of interlayer seeks (number of interlayer shifts), and the number of times of parameter adjustment, received via the system controller 108. The recording time computation section 111 selects a use pattern of which the derived total recording time is shortest.

The address conversion section 112 determines a starting physical address indicating the recording start position and an ending physical address indicating the recording end position for each of recording layers used in the use pattern selected by the recording time computation section 111, and stores such addresses in the memory 107 as conversion information. Based on the conversion information stored in the memory 107, the address conversion section 112 converts a logical address to be accessed received from the host device 120 via the system controller 108 to a physical address on the optical disc 101, and also converts a physical address on the optical disc 101 to a logical address to be accessed.

The interface 113 is used for communication between the system controller 108 and the host device 120.

<Configuration of Optical Disc 101>

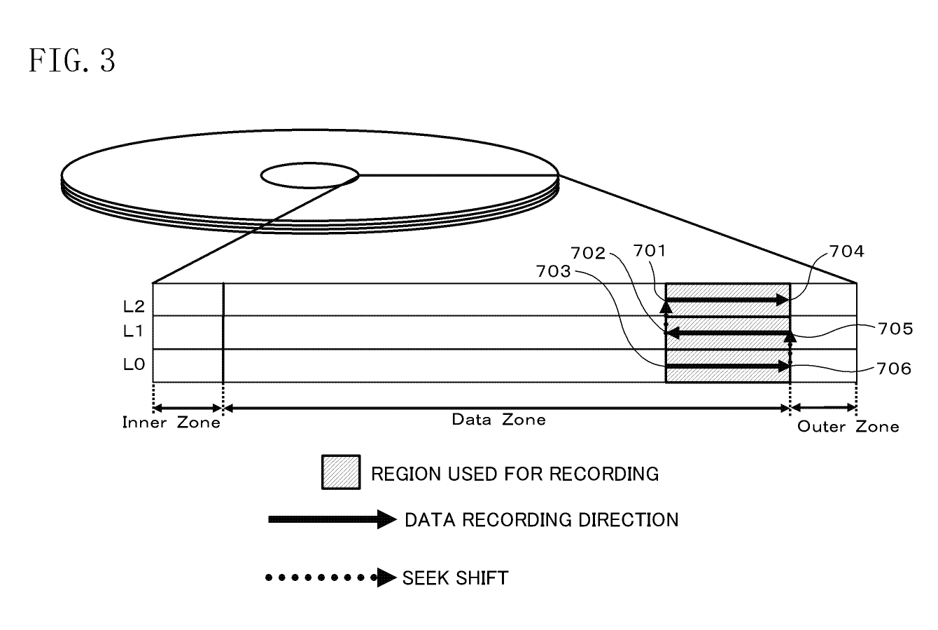

The optical disc 101 on which data is to be recorded has three recording layers of an opposite track path scheme as shown in FIG. 3. That is, a recording layer on which data is recorded from inner to outer portions and a recording layer on which data is recorded from outer to inner portions lie one upon another alternately. The three recording layers are denoted by L0, L1, and L2. Each recording layer is divided into an inner zone, a data zone, and an outer zone, and data to be recorded by the user is allocated to the data zone. Each of the inner and outer zones has a region for recording calibration, a disc management region, and a control information region, although not shown. The region for recording calibration is used for learning the laser power required for data recording and a write strategy suitable for the state of the optical disc 101 and the status of the optical disc recording/reproduction device 100, i.e., a pattern of recording pulses, prior to recording of data on the optical disc 101. In the disc management region, information required for data access and information on a defective sector are recorded. The control information region, in which information on the optical disc 101 is recorded in advance, is used for control of the optical disc recording/reproduction device 100.

<Configuration of Host Device 120>

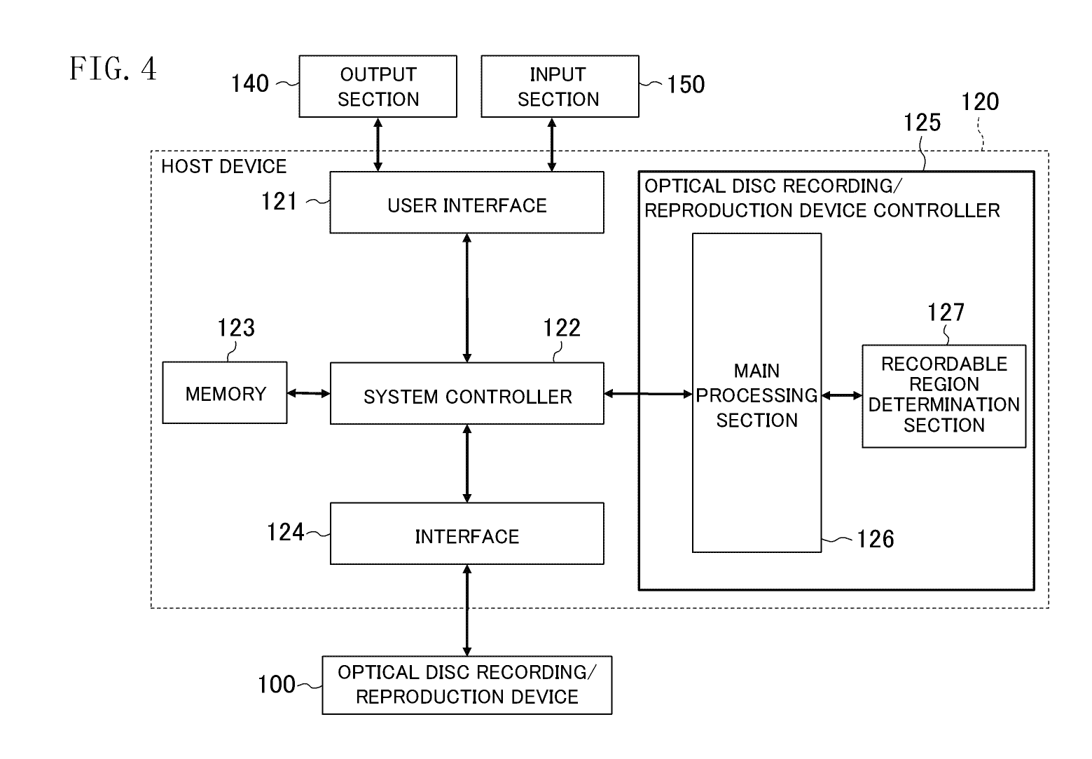

As shown in FIG. 4, the host device 120 includes a user interface 121, a system controller (capacity determination section) 122, a memory 123, an interface 124, and an optical disc recording/reproduction device controller 125. Functions of the host device 120 are implemented by allowing a computer to execute a program recorded in an information recording medium such as an optical disc, a magnetic disc, and a nonvolatile semiconductor memory (including any type of ROM). More specifically, functions of the host device 120 may be implemented by a device driver to make the functions available to various applications, or implemented by individual application programs.

The user interface 121 is used for data communication between the host device 120 and the user.

The system controller 122 controls the blocks of the host device 120.

The memory 123 stores data according to instructions from the system controller 122 or according to instructions from any of the blocks via the system controller 122.

The interface 124 is used for data communication between the optical disc recording/reproduction device 100 and the host device 120.

The optical disc recording/reproduction device controller 125, which controls the optical disc recording/reproduction device 100, includes a main processing section (capacity notification section) 126 and a recordable region determination section 127.

The main processing section 126 performs various types of information processing. The recordable region determination section 127 determines recordable regions in the data zone of the optical disc 101 based on the received optical disc management information.

<Logical Address Space>

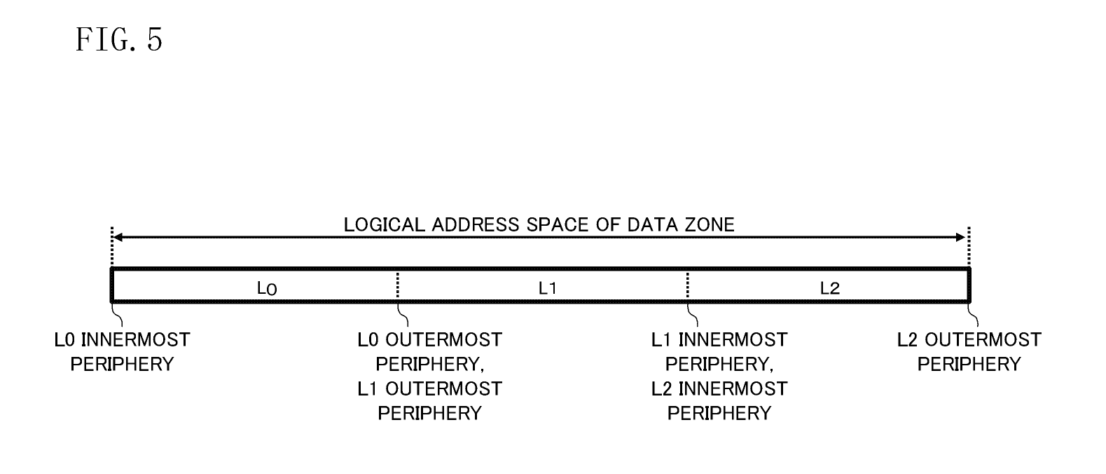

FIG. 5 is a view illustrating the logical address space of the data zone. Continuous addresses independent of the number of recording layers of the optical disc 101 and the physical layout of the optical disc 101 are assigned to recording positions in the address space recognized by the host device 120. When recording is performed continuously over the entire data zone of the optical disc 101, logical addresses are assigned in the order of innermost periphery of L0→outermost periphery of L0→outermost periphery of L1→innermost periphery of L1→innermost periphery of L2→outermost periphery of L2→for the optical disc 101 that adopts the opposite track path scheme.

<Operation of Optical Disc Recording System>

An operation of the optical disc recording system of recording data to be recorded on the optical disc 101 in a CAV control mode will be described hereinafter.

Once the optical disc 101 is loaded to the optical disc recording/reproduction device 100, the spindle motor 102 rotates the optical disc 101, and the optical pickup 103 irradiates the optical disc 101 with laser light. The servo control section 104 performs tracking and focusing, and by “spin-up” operation, the optical disc recording/reproduction device 100 starts up to its recording/reproduction-ready state. Once starting the spin-up operation, the optical disc recording/reproduction device 100 notifies the host device 120 that it is under the startup. During the spin-up operation, the optical disc recording/reproduction device 100 reads information in the disc management region and control information region of the optical disc 101 and stores the read information in the memory 107 as the optical disc management information. The recordable region determination section 109 receives the optical disc management information stored in the memory 107, determines recordable regions in the data zone of the optical disc 101 based on the optical disc management information, and stores information indicating the determined recordable regions in the memory 107 as the recordable region determination information.

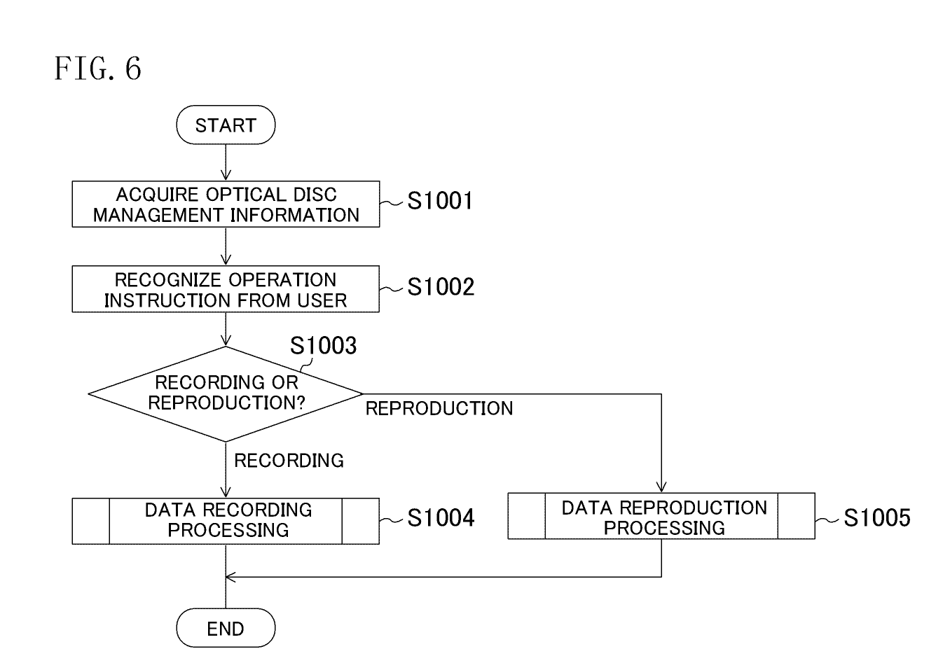

The operation shown in the flowchart of FIG. 6 starts in the state described above.

(S1001) The optical disc recording/reproduction device 100 transmits the information on the optical disc 101 read during the spin-up operation, i.e., the optical disc management information, and drive information on the optical disc recording/reproduction device 100 to the host device 120. The host device 120 receives the optical disc management information and the drive information and stores them in the memory 123. The optical disc recording/reproduction device controller 125 determines the capacity and format of data recorded on the optical disc 101, the address indicating the recorded position of the data, the recording speed achievable by the optical disc recording/reproduction device 100, etc. based on the optical disc management information, and outputs some of the determined information required to the output section 140 via the user interface 121.

(S1002) Once the user inputs an operation instruction into the host device 120 via the input section 150, the system controller 122 of the host device 120 sends an operation instruction signal corresponding to the input operation instruction to the optical disc recording/reproduction device controller 125, where the main processing section 126 receives the operation instruction signal. When giving a recording instruction as the operation instruction, the user specifies the recording speed via the input section 150. That is, the user selects a recording speed out of the achievable recording speeds output to the output section 140 in (S1001). Also, when receiving a recording instruction, the system controller 122 determines the capacity of the data to be recorded under the instruction (data to be recorded) and the recording speed specified by the user.

(S1003) The main processing section 126 determines which the operation instruction from the user is, recording or reproduction, based on the operation instruction signal. The process proceeds to (S1004) if the user's operation instruction is recording, or to (S1005) if it is reproduction.

(S1004) The optical disc recording system performs data recording processing.

(S1005) The optical disc recording system performs data reproduction processing.

<Data Recording Processing>

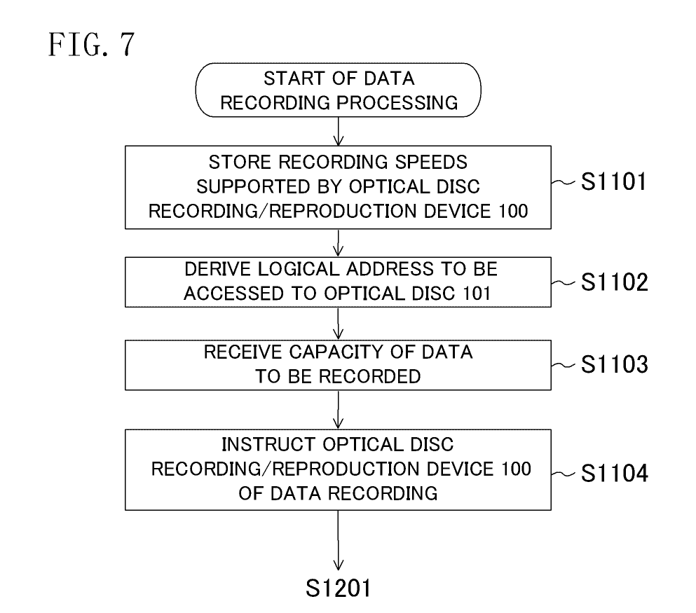

The data recording processing in (S1004) will be described. First, the operation shown in the flowchart of FIG. 7 is performed.

(S1101) In the host device 120, the main processing section 126 receives the optical disc management information and the drive information on the optical disc recording/reproduction device 100 from the memory 123, and stores recording speeds achievable in data recording on the optical disc 101.

(S1102) The recordable region determination section 127 determines regions on which no data has been recorded as recordable regions based on the optical disc management information, and the main processing section 126 derives a logical address to be accessed at which recording of the data to be recorded is started.

(S1103) The main processing section 126 then receives the capacity of the data to be recorded under the recording instruction from the user and the recording speed specified by the user, from the system controller 122. Note that the capacity of the data to be recorded and the recording speed are the ones determined by the system controller 122 when having received the recording instruction from the user.

(S1104) The main processing section 126 instructs the optical disc recording/reproduction device 100 of data recording while notifying the device 100 of the logical address to be accessed derived in (S1102) and the capacity of the data to be recorded and the recording speed received in (S1103).

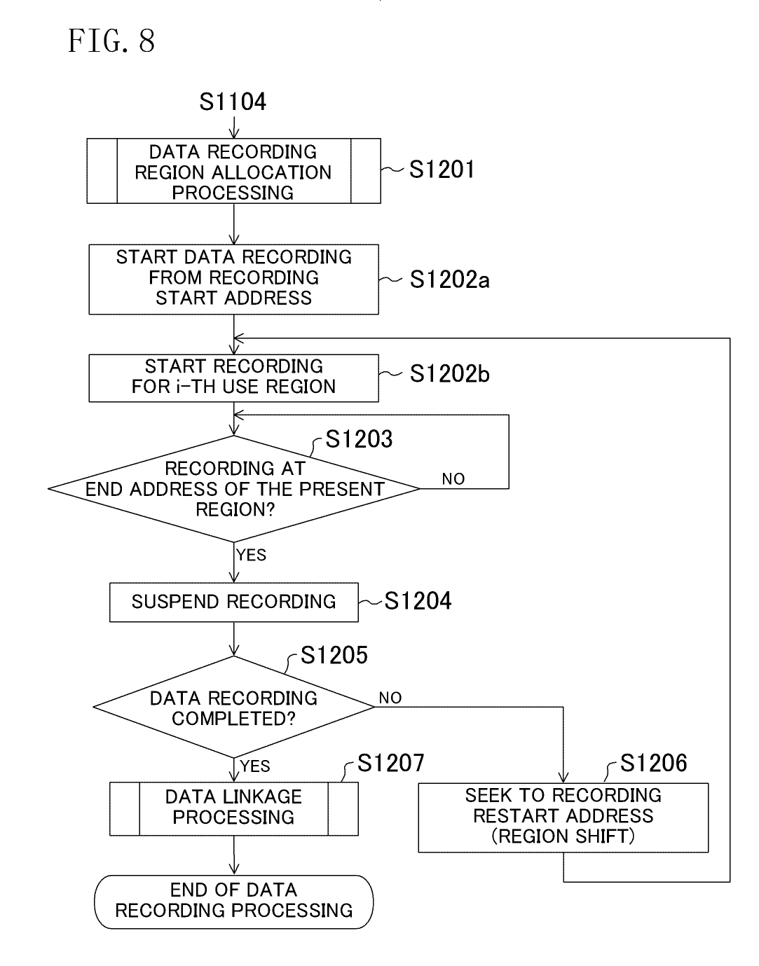

Subsequently, once receiving the instruction in (S1104) from the host device 120, the optical disc recording/reproduction device 100 starts the recording processing shown in the flowchart of FIG. 8. Also, the optical disc recording/reproduction device 100 stores, in the memory 107, the logical address to be accessed, the capacity of the data to be recorded, and the recording speed specified by the user transmitted from the host device 120 along with the recording instruction. The recording processing shown in the flowchart of FIG. 8 will be described hereinafter.

(S1201) The optical disc recording/reproduction device 100 determines use regions used for recording of the data to be recorded. More specifically, the starting physical address indicating the recording start position and the ending physical address indicating the recording end position are determined for each use region. The use order of the use regions is also determined. Since a plurality of use regions will not be determined for one recording layer in this embodiment, the use order of the use regions means the use order of the recording layers. The address conversion section 112 reads the logical address to be accessed (starting logical address) transmitted from the host device 120 from the memory 107, and converts the logical address to be accessed to the starting physical address of the use region first used for recording. The processing in (S1201) will be described later in detail.

(S1202a) The system controller 108 reads the starting physical address and ending physical address of each use region (recording layer), as well as the use order, determined by the address conversion section 112 from the memory 107, where i=1 is set. Recording calibration is then executed for each recording layer used. That is, when a plurality of recording layers are used for recording, recording calibration is executed for the individual recording layers.

(S1202b) The optical disc recording/reproduction device 100 starts data recording from the recording start position indicated by the starting physical address of the i-th use region.

(S1203) In the optical disc recording/reproduction device 100, in parallel with the recording operation of the data to be recorded, the system controller 108 checks whether or not recording has been completed up to the ending physical address of the i-th use region. If recording has not been completed up to the ending physical address, the optical disc recording/reproduction device 100 repeats the processing in (S1203). Otherwise, the process proceeds to (S1204).

(S1204) The optical disc recording/reproduction device 100 suspends recording.

(S1205) The system controller 108 checks whether or not recording of the entire data to be recorded has been completed. The process proceeds to (S1206) if recording has not been completed, or otherwise proceeds to (S1207).

(S1206) The optical disc recording/reproduction device 100 sets i=i+1, and seeks to the starting physical address of the use region next used for recording, i.e., the i-th use region before returning to (S1202b).

(S1207) The system controller 108 stores the ending physical address in the memory 107, and links the separately recorded data units with each other. The processing in this step will be described later in detail.

<Data Recording Region Allocation Processing>

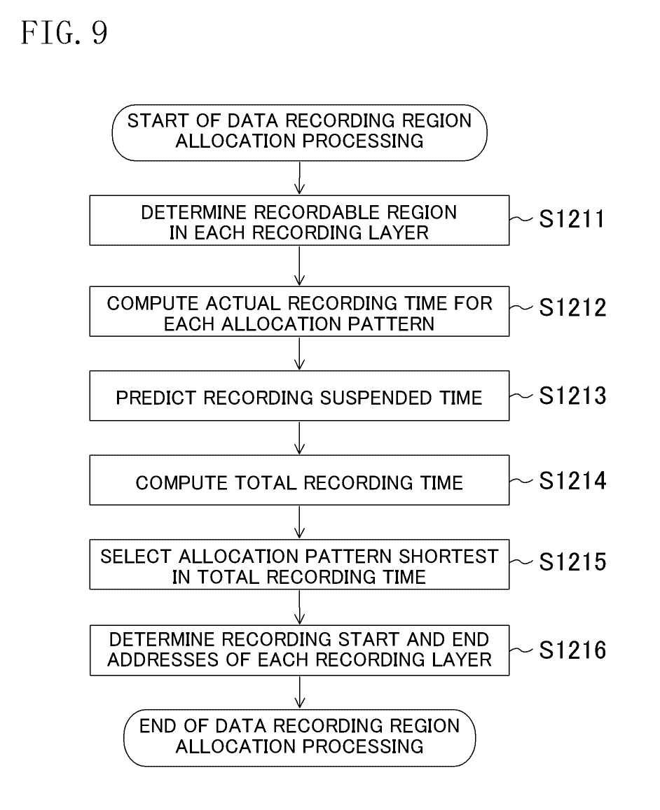

The processing in (S1201) will be described in detail with reference to the flowchart of FIG. 9.

(S1211) The address conversion section 112 reads the recordable region determination information from the memory 107 and determines recordable regions in the layers L0, L1, and L2.

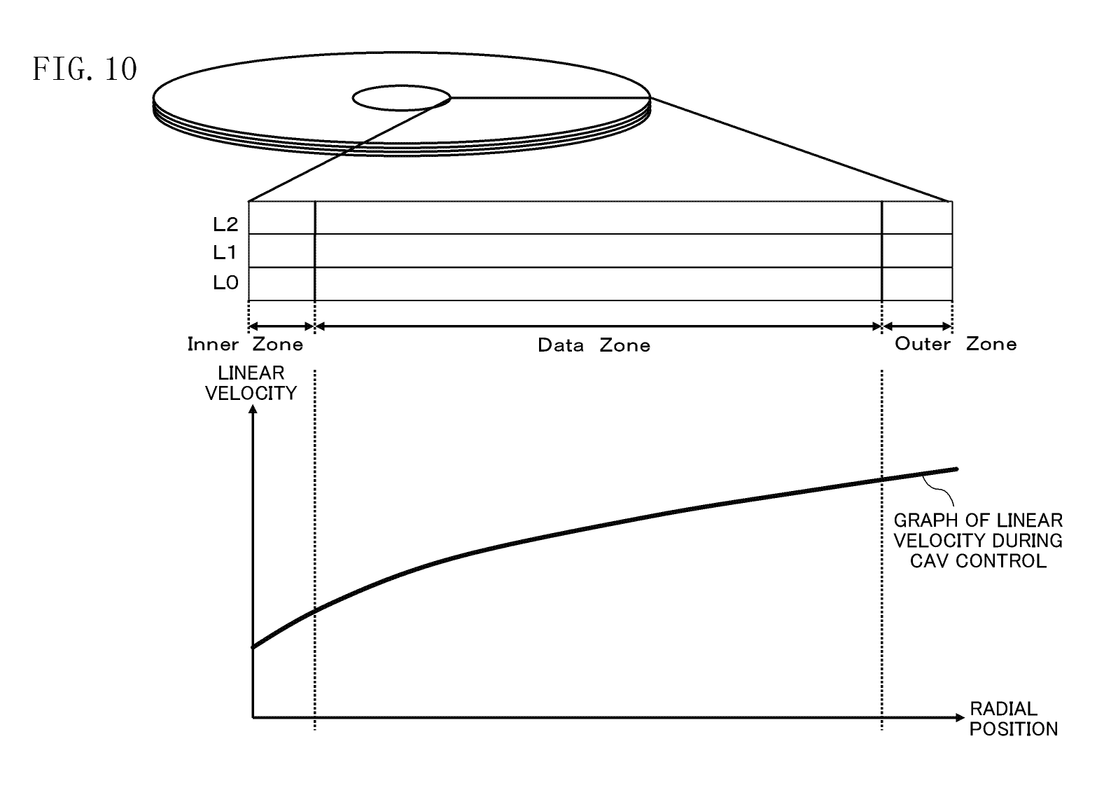

(S1212) The address conversion section 112 reads the capacity of the data to be recorded and the recording speed from the memory 107, and derives a graph indicating the relationship between the radial position of recordable regions in the layers L0, L1, and L2 and the linear velocity based on the read recording speed. FIG. 10 shows an example of the derived graph. In this graph, since the number of revolutions of the spindle motor is constant, the linear velocity is higher as the radial position is farther from the innermost periphery.

Thereafter, the recording time computation section 111 determines a plurality of use patterns in which given recordable regions are used for recording of the data to be recorded in given use order, and computes the actual recording time for each of the determined use patterns based on the graph derived by the address conversion section 112.

Specifically, the recording time computation section 111 determines use patterns different in the number of recording layers used. More specifically, any use pattern that belongs to any of the following use patterns (A), (B), and (C) and in which the capacity of the total recordable regions in the recording layer(s) used is larger than the capacity of the data to be recorded is determined.

(A) Use pattern using a recordable region in any one of the layers L0, L1, and L2

(B) Use pattern using recordable regions in any two of the layers L0, L1, and L2

(C) Use pattern using recordable regions in all the layers L0, L1, and L2

Also, any use pattern satisfying the following conditions is determined.

(a) The linear velocity in any recordable region used is equal to or higher than that in any recordable region unused. Therefore, in the recording in the CAV control mode, any recordable region used includes the outermost periphery of the recordable region(s), and does not include a region closer to the innermost periphery than any recordable region unused for recording of the data to be recorded in the use pattern in question.

(b) In the recording according to a determined use pattern, there is no direct interlayer shift between recording layers having the same recording direction, i.e., no direct interlayer shift from L0 to L2. In other words, any interlayer shift should be performed to a recording layer opposite in the scanning direction to its immediately preceding recording layer.

When no data has been recorded in the data zone of the optical disc 101, a use pattern in which the capacities of the regions in the recording layers used are equal to each other is determined. When data has been already recorded in the data zone of the optical disc 101, a use pattern is determined so that the capacity of the recordable region to be used in each recording layer is equal to or less than the capacity of the recordable region in the recording layer determined by the recordable region determination section 127 in (S1102).

(S1213) The recording time computation section 111 predicts a recording suspended time for all use patterns of which the actual recording time has been computed in (S1212). The recording suspended time is the sum of prediction values of the seek time and the recording calibration time as the time required for adjustment of parameters used for the recording. The seek time in each use pattern is computed based on the focus position switching time, the radial position shift velocity, and the radial position shift distance and the number of times of focus position switching required in the use pattern. The focus position switching time and the radial position shift velocity are measured in advance and stored in the memory 107. The recording calibration time in each use pattern is computed based on the time required to execute one time of recording calibration and the number of times of recording calibration required in the use pattern. The time required to execute one time of recording calibration is measured in advance and stored in the memory 107. When two or more recording layers are to be used, there exist a plurality of use patterns that use the same recording layers in different use order. In such a case, the seek time is computed only for a use pattern, out of such use patterns, which uses the recording layers in a sequence in which the radial position shift distance is shortest. When there exist a plurality of sequences in which the radial position shift distance is shortest, only a use pattern in which a smaller-numbered recording layer is used earlier is computed. The number of times of recording calibration is considered the same as the number of recording layers used.

(S1214) The recording time computation section 111 computes the total recording time as the sum of the actual recording time computed in (S1212) and the recording suspended time computed in (S1213) for all the use patterns of which the actual recording time has been computed in (S1212).

(S1215) The recording time computation section 111 selects a use pattern of which the total recording time computed in (S1214) is shortest. When a plurality of use pattern have the shortest total recording time, a use pattern of which the recording suspended time is shortest is selected.

A method of the above selection will be described. The recording time computation section 111 first performs a selection operation of selecting a use pattern shorter in total recording time between the use pattern (A) using one recording layer and the use pattern (B) using two recording layers. If the use pattern (A) is selected, the use pattern (A) is determined as the use pattern shortest in total recording time. If the use pattern (B) is selected, another selection operation is performed between the use pattern (B) and the use pattern (C), and the use pattern selected under this selection is determined as the use pattern shortest in total recording time.

When the number of recording layers is m that is a number equal to or more than 4, also, a use pattern may be selected by a selection operation of selecting a use pattern shorter in total recording time between the first use pattern using n (n is a natural number) recording layer(s) for recording of the data to be recorded and the second use pattern using (n+1) recording layers. More specifically, repetition operation is started in which the selection operation is repeated by incrementing n by one at a time from 1 until n=m−1. If the second use pattern is selected in every selection operation during the repetition operation, a use pattern of using m recording layers may be determined. If the first use pattern is selected in a given selection operation during the repetition operation, the first use pattern in this selection operation that has first selected the first use pattern may be determined.

(S1216) The address conversion section 112 determines the recordable region(s) used in the use pattern selected in (S1215) as the use region(s). More specifically, the address conversion section 112 determines the starting physical address and ending physical address of each use region, and stores the results in the memory 107 as conversion information used for conversion of the logical address to be accessed to a physical address. The address conversion section 112 also determines the use order of the use regions in the use pattern selected in (S1215), and stores the result in the memory 107. Thereafter, the address conversion section 112 converts the logical address to be accessed transmitted from the host device 120 to a physical address based on the conversion information stored in the memory 107.

Subsequently, in (S1202) to (S1206) in FIG. 8, the data to be recorded is recorded according to the use pattern selected in (S1215). When a use pattern using a plurality of recording layers is used to record the data to be recorded, the data division section 110 divides the data to be recorded and allocates divided data units to the recording layers.

The data to be recorded is recorded in recordable regions where no data has been recorded, and not recorded in region where data has already been recorded.

<Data Linkage Processing>

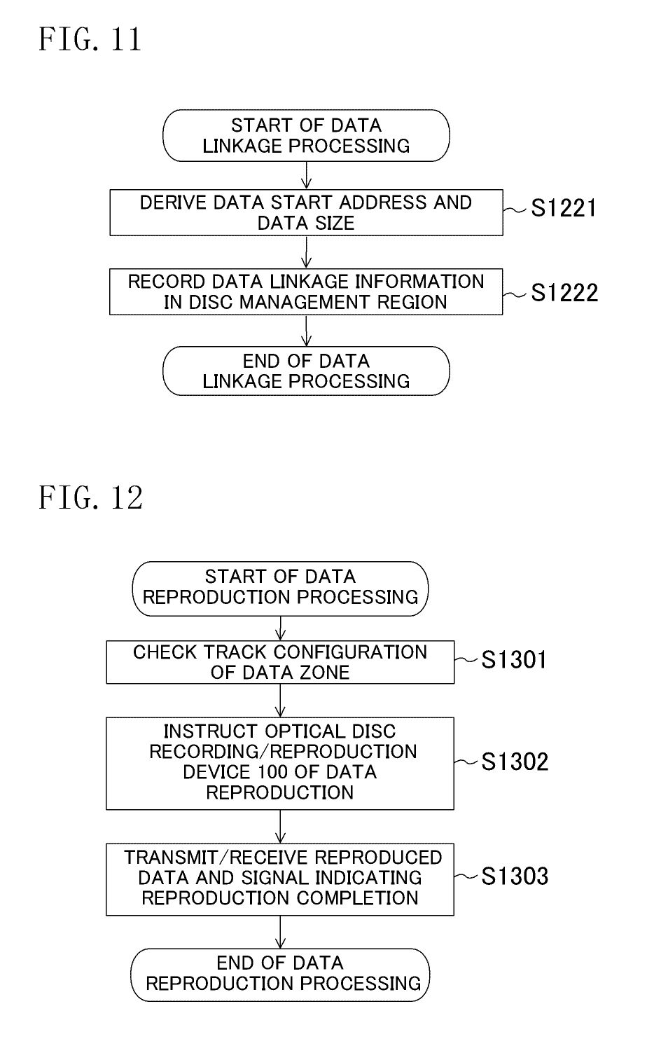

The processing in (S1207) will be described in detail with reference to the flowchart of FIG. 11.

(S1221) The optical disc recording/reproduction device 100 derives the data size of each use region used for recording of the data to be recorded based on the difference between the starting physical address and ending physical address of the use region.

(S1222) The optical disc recording/reproduction device 100 records linkage information in the disc management region of the optical disc 101 so that the separately recorded data units can be reproduced as one data track. The linkage information indicates use regions used for recording of the data to be recorded and the use order of such use regions. More specifically, the starting physical addresses and data sizes of the use regions are listed in order of use.

For example, when three recording layers of the optical disc 101 are used for recording of the data to be recorded as shown in FIG. 3, the linkage information includes the starting physical address of the recording layer L0, the data size of data recorded in the recording layer L0, the starting physical address of the recording layer L1, the data size of data recorded in the recording layer L1, the starting physical address of the recording layer L2, and the data size of data recorded in the recording layer L2, recorded sequentially. When the number of layers used is one, one pair of the starting physical address and the data size are recorded, and when the number of layers used is two, two pairs of the starting physical addresses and the data sizes are recorded.

With the linkage information recorded in the disc management region of the optical disc 101 as described above, the address conversion section 112 of the optical disc recording/reproduction device 100 reads the linkage information from the optical disc 101 at the time of reproduction of the data recorded, and can convert the logical address to be accessed transmitted from the host device 120 to a physical address based on the read linkage information.

Once the data linkage processing is terminated, the address conversion section 112 associates the linkage information recorded in the disc management region with the logical address to be accessed received from the host device 120, and transmits, to the host device 120, a signal indicating that the data recording related to the specified logical address to be accessed has been performed, thereby to complete the recording processing.

<Data Reproduction Processing>

The data reproduction processing in (S1005) in FIG. 6 will be described. In (S1005), processing as shown in the flowchart of FIG. 12 is performed.

(S1301) The main processing section 126 of the host device 120 receives the optical disc management information from the memory 123, to grasp the configuration of data tracks in the data zone.

(S1302) The main processing section 126 of the host device 120 transmits the logical address to be accessed to a data track to be reproduced under a reproduction instruction, as well as the data size, to the optical disc recording/reproduction device 100, and instructs the optical disc recording/reproduction device 100 of data reproduction.

(S1303) The optical disc recording/reproduction device 100 performs data reproduction according to the logical address to be accessed transmitted from the host device 120 in (S1302), and then transmits the reproduced data and a signal indicating completion of the reproduction to the host device 120. The host device 120 receives the data and the signal, thereby to terminate the data reproduction processing.

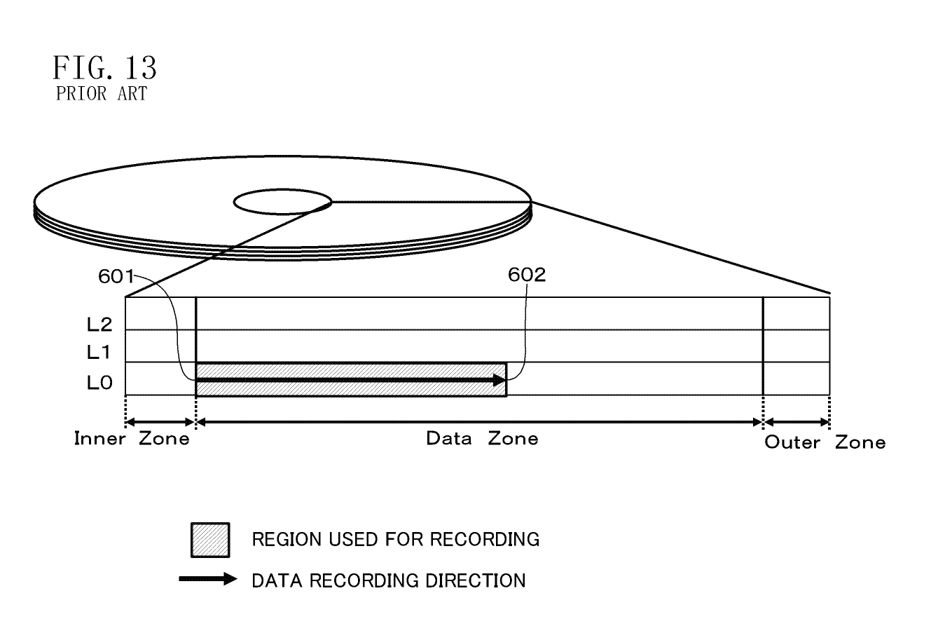

FIG. 3 shows an example of a use pattern selected in the data recording region allocation processing in (S1201). In FIG. 3, in each of the three recording layers of the optical disc 101 in its non-recorded state, an outermost portion of the data zone is used for recording of the data to be recorded, and thus the data to be recorded is divided into three equal parts. In other words, regions equal in capacity to one another are used for recording of the data recording in the recording layers used for the recording. In this case, the address conversion section 112 stores, in the memory 107 as the conversion information, a starting physical address 703 of L0, an ending physical address 706 of L0, a starting physical address 705 of L1, an ending physical address 702 of L1, a starting physical address 701 of L2, and an ending physical address 704 of L2. The layers are used in the order of L0, L1, and L2, and the starting physical address 703 of L0 and the ending physical address 704 of L2 are respectively the entire data recording start address and the entire data recording end address. FIG. 13 shows a conventional method of recording data on an optical disc. In FIG. 13, recording is performed in one recording layer of the optical disc 101 from inner to outer portions. More specifically, data to be recorded is allocated from the innermost periphery of L0, where 601 denotes the entire data recording start address and 602 denotes the entire data recording end address. In FIG. 3, in comparison with FIG. 13, a continuous region including the outermost periphery of the data zone of the optical disc 101 at which the recording velocity is high is used. Also, a use pattern, among a plurality of use patterns different in the number of recording layers used, which is shortest in computed total recording time is used. In the method of FIG. 3, therefore, the recording time is shorter than in the method of FIG. 13.

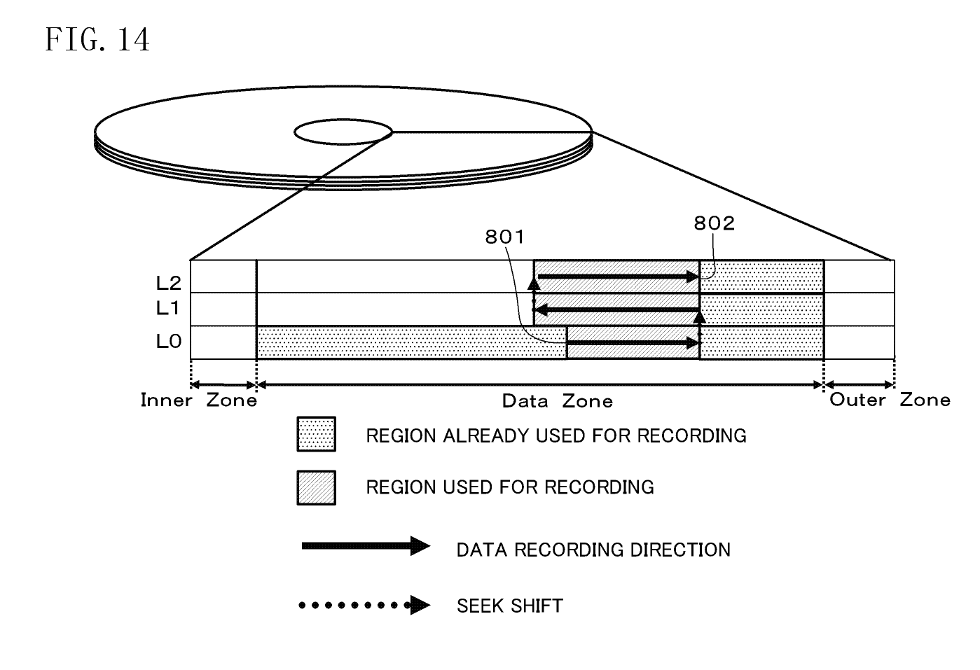

FIG. 14 shows an example of a use pattern selected in (S1201) in the case of addition of data to be recorded to the optical disc 101 on which data has already been recorded in the data zone. On the optical disc 101 in FIG. 14, recording by the conventional data recording method of FIG. 13 and recording according to the use pattern of FIG. 3 have already been performed before addition of the data to be recorded. The remaining regions of the optical disc 101, i.e., the regions on which no data has been recorded are allocated for addition of the data to be recorded. Also, in each of the three recording layers of the optical disc 101, a continuous region including the outermost periphery of the non-recorded region in the data zone is allocated for recording of the data to be recorded, and thus the data to be recorded is divided into three parts. The recording layers L0, L1, and L2 are used in this order, and a starting physical address 801 of L0 and an ending physical address 802 of L2 are respectively the entire data recording start address and the entire data recording end address.

According to this embodiment, since data to be recorded is recorded according to a use pattern of which the total recording time is shortest, the total recording time is shortened.

Also, since the data to be recorded is recorded on an outer portion of the data zone, the number of revolutions of the spindle motor is reduced, permitting reduction in power consumption and also reduction in access time to recorded data when the data is reproduced in the CAV control mode or a ZCLV control mode.

### Variations of First Embodiment

In the first embodiment described above, although the optical disc 101 on which data is to be recorded adopts the opposite track path scheme, it may adopt a parallel track path scheme. In this case, it is only necessary to give no consideration to the condition (b) that there is no direct interlayer shift between recording layers having the same recording direction for determination of the use pattern in (S1212).

In the first embodiment, in (S1212), the optical disc recording/reproduction device 100 derives the graph indicating the relationship between the radial position and the linear velocity based on the recording speed, and computes the actual recording time based on this graph. The method of computing the actual recording time is not limited to this. For example, only one type of recording speed may be made available to the optical disc recording/reproduction device 100, and no operation of deriving the above graph may be performed, but a graph stored in advance may be referred to for derivation of the actual recording time.

In the first embodiment, data to be recorded is allocated to a region including the outermost periphery of a recordable region. That is, data to be recorded is allocated so that the actual recording time is shortest. The way of allocation is not limited to this, but another way may be adopted as long as data to be recorded is allocated so that the actual recording time is shorter compared with the case shown in FIG. 13 where data to be recorded is allocated in a recordable region from inner to outer portions sequentially.

If there is a time, other than the actual recording time, required between the start and end of data recording, such a time may be included in the recording suspended time in addition to the seek time and the recording calibration time.

Although the logical address to be accessed, the capacity of the data to be recorded, and the recording speed are transmitted from the host device 120 to the optical disc recording/reproduction device 100, the information transmitted is not limited to these. For example, when only one type of recording speed is available to the optical disc recording/reproduction device 100, transmission of the recording speed may be omitted.

The data recording region allocation processing and the data linkage processing in the first embodiment described above are applicable, not only to the case that the entire regions of the optical disc are subjected to recording in the CAV control mode, but also to the case that, while some regions of the optical disc are subjected to recording in a control mode other than CAV, the remaining regions are subjected to recording in the CAV control mode.

In the first embodiment, the functions of the control device 114 are implemented by a plurality of processing sections. The configuration of the control device 114 is not limited to this, but the functions may be implemented by one-chip large scale integration (LSI), for example.

### Second Embodiment

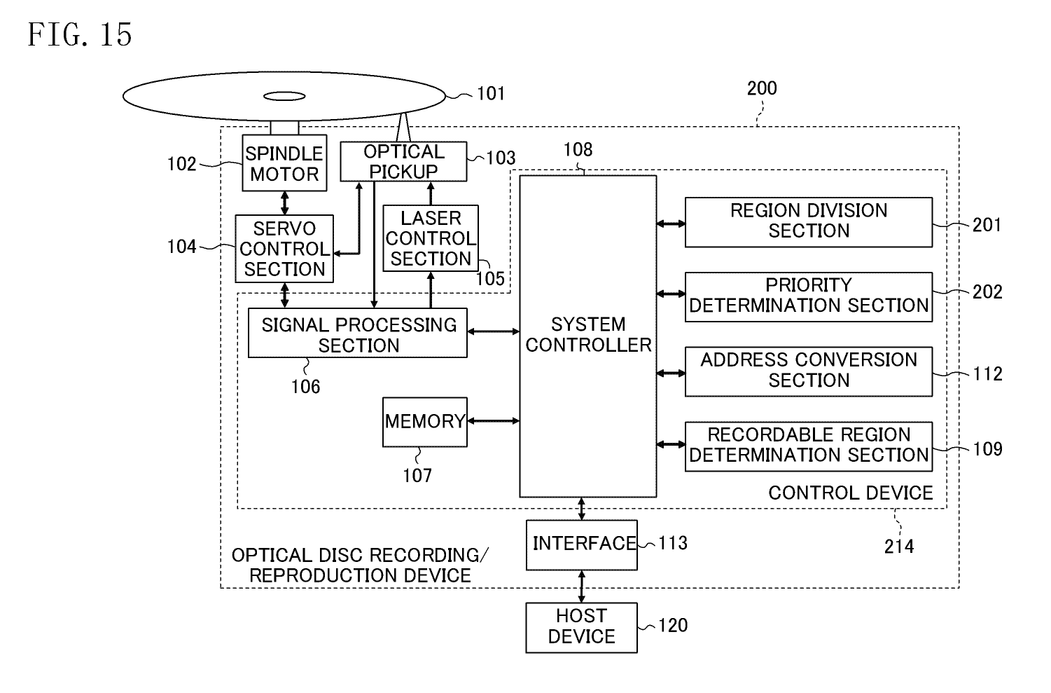

An optical disc recording system of the second embodiment of the present invention includes an optical disc recording/reproduction device 200 shown in FIG. 15 in place of the optical disc recording/reproduction device 100 in the first embodiment. As shown in FIG. 15, the optical disc recording/reproduction device 200 includes a region division section 201 and a priority determination section 202 in addition to the components of the optical disc recording/reproduction device 100 in the first embodiment, and does not include the data division section 110 nor the recording time computation section 111. The signal processing section 106, the memory 107, the system controller 108, the recordable region determination section 109, the address conversion section 112, the region division section 201, and the priority determination section 202 constitute a control device 214 that controls the optical pickup 103 indirectly. The control device 214 executes a program recorded in an information recording medium such as an optical disc, a magnetic disc, and a nonvolatile semiconductor memory (including any type of ROM), thereby to implement functions of the optical disc recording/reproduction device 200. The control device 214 may otherwise execute the program recorded in the information recording medium after loading the program into a volatile semiconductor memory such as RAM.

The region division section 201 receives the recordable region determination information stored in the memory 107 by the recordable region determination section 109 via the system controller 108, and divides recordable regions determined by the received recordable region determination information in the radial direction, to give a plurality of divided zones (divided regions).

The priority determination section 202 determines the priority of each divided zone given by the region division section 201.

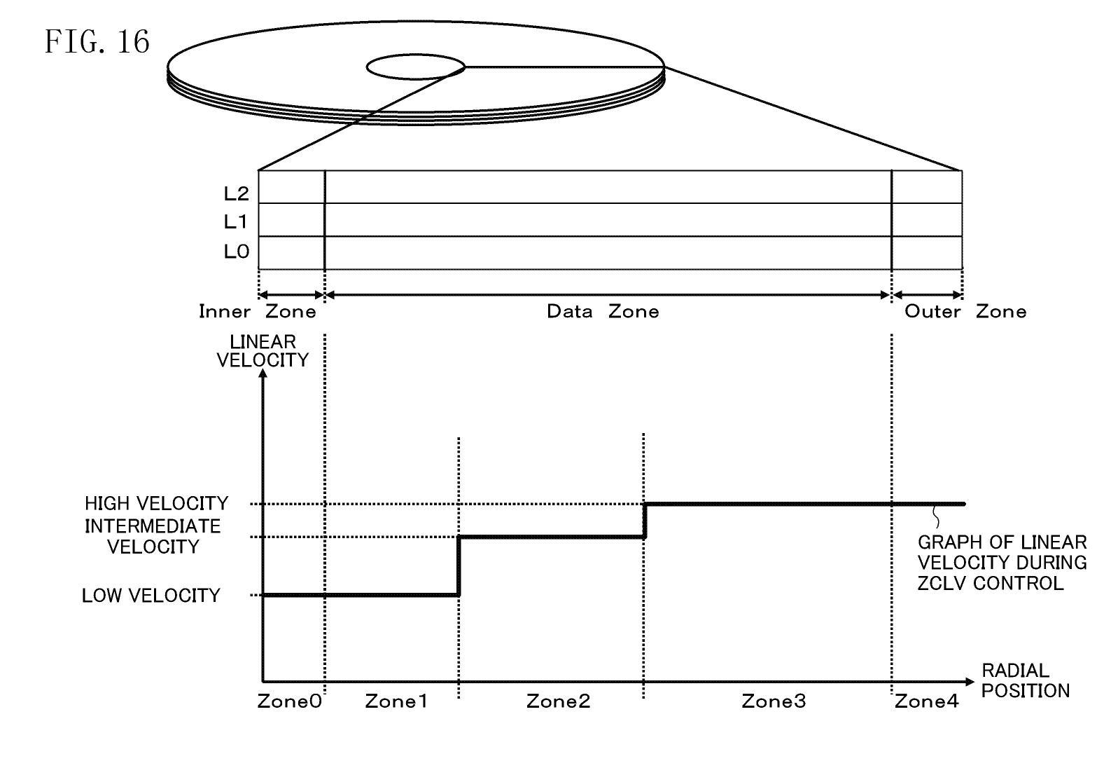

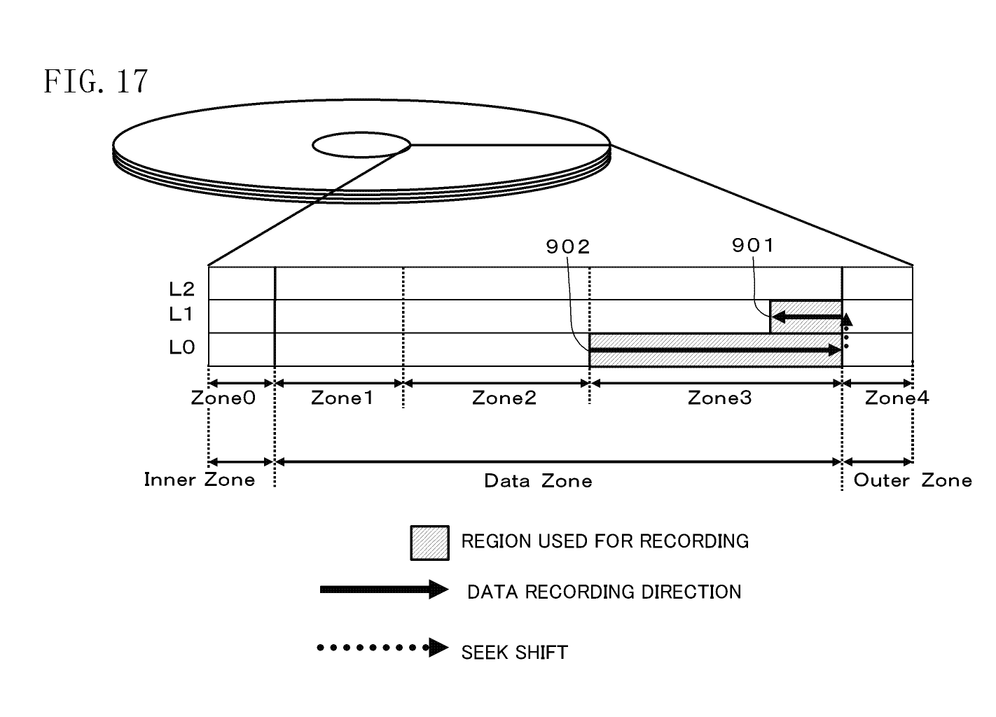

FIG. 16 shows divided zones of the optical disc 101 in the case of adopting the ZCLV control mode. There are five divided zones, Zone 0 to Zone 4, in which Zone 0 is allocated to the inner zone of the optical disc, Zone 4 to the outer zone, and Zone 1 to Zone 3 to the data zone. Recording/reproduction is performed at a constant linear velocity within each divided zone: it is at a low velocity in Zone 0 and Zone 1, at an intermediate velocity in Zone 2, and at a high velocity in Zone 3 and Zone 4. The start address of each divided zone is stored in advance in the memory 107, and each divided zone is determined by reading the start address from the memory 107. In FIGS. 17, 18, and 19, also, the recordable regions of the optical disc 101 are divided into Zone 0 to Zone 4 in the radial direction as in FIG. 16.

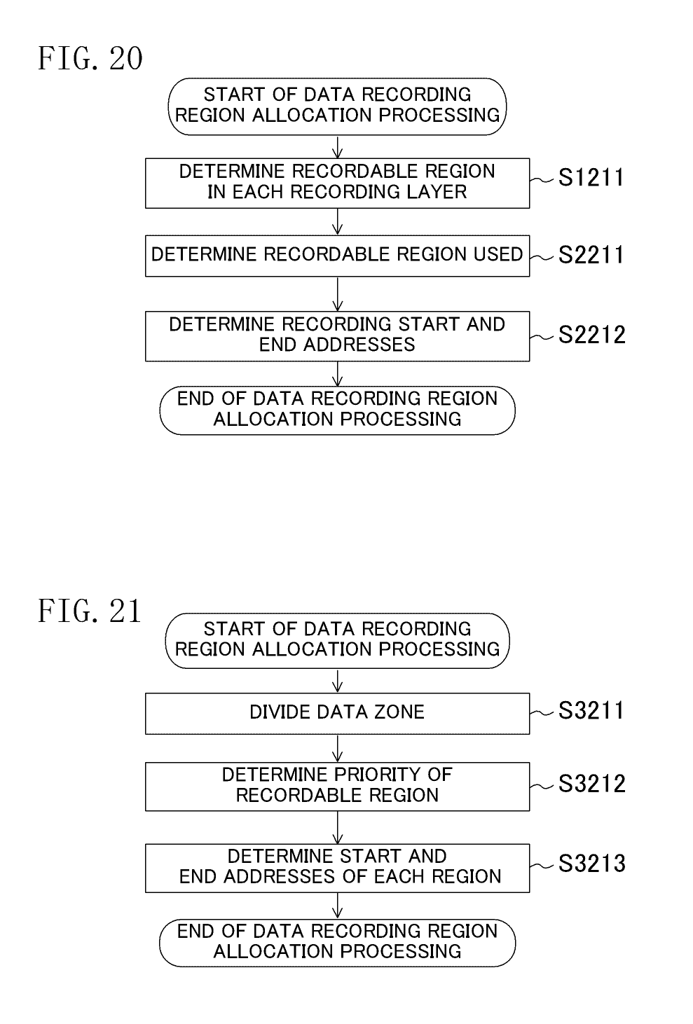

When recording the data to be recorded on the optical disc 101 in the ZCLV control mode, the optical disc recording system of this embodiment performs processing of (S2211) and (S2212) shown in FIG. 20, in place of the processing of (S1212) to (S1216) in the first embodiment described above. The other processing of the optical disc recording system of this embodiment is similar to that of the optical disc recording system of the first embodiment in the CAV control mode. Detailed description thereof is therefore omitted.

(S2211) The region division section 201 determines use regions used for recording of divided data to be recorded.

More specifically, first, the region division section 201 reads the capacity of the data to be recorded from the memory 107, and determines the recordable regions in the divided zones as use regions for recording of the data to be recorded sequentially in the order of Zone 3, Zone 2, and Zone 1, i.e., in order of decreasing linear velocity, so that the total of the capacities of the use regions determined becomes equal to the capacity of the data to be recorded read from the memory 107. In one divided zone, the recordable regions are determined as use regions in the order of L0, L1, and L2. That is, use regions are determined in the order of L0 in Zone 3, L1 in Zone 3, L2 in Zone 3, L0 in Zone 2, L1 in Zone 2, L2 in Zone 2, L0 in Zone 1, L1 in Zone 1, and L2 in Zone 1.

FIG. 17 shows an example of use regions determined when recording is performed for the optical disc 101 in its non-recorded state, in which regions are determined as use regions sequentially from the head address of L0 in Zone 3 up to some midpoint in L1 in Zone 3.

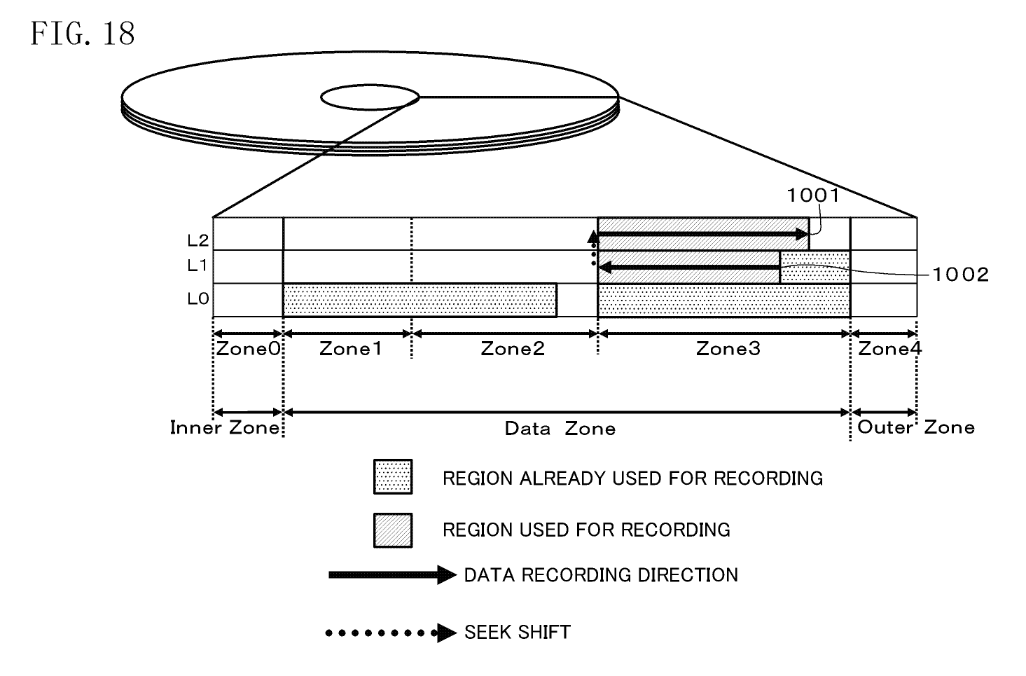

FIG. 18 shows an example of use regions determined when data to be recorded is added to the optical disc 101 on which recording by the conventional method of FIG. 13 and recording in the use regions determined in FIG. 17 have already been performed. Regions from the midpoint in L1 in Zone 3 up to some midpoint in L2 in Zone 3 are determined as the use regions.

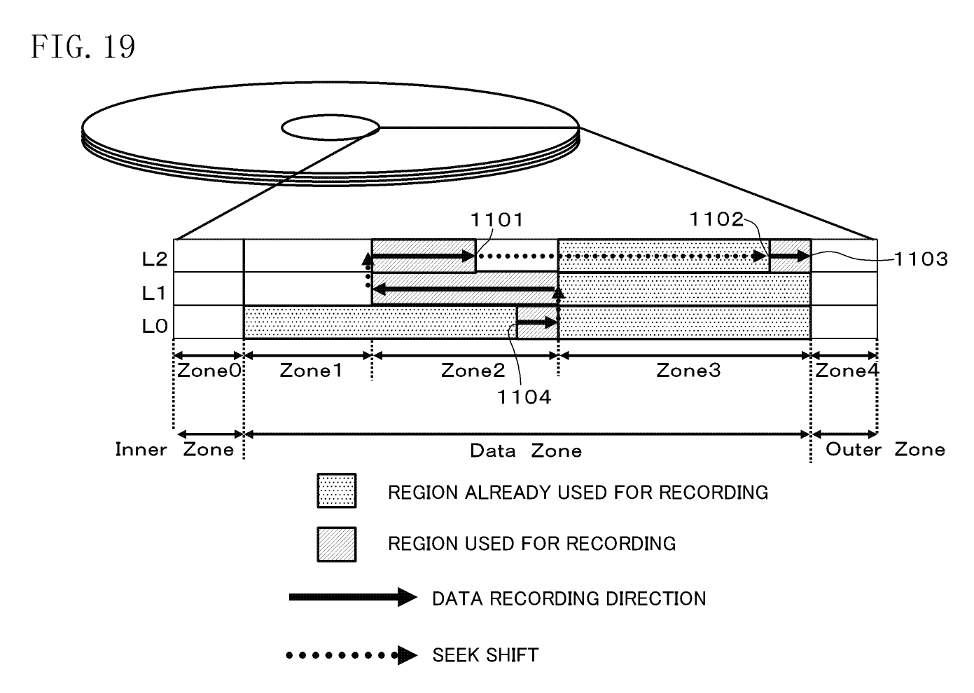

FIG. 19 shows an example of use regions determined when data to be recorded is added to the optical disc 101 on which data has already been recorded in the use regions determined in FIG. 18. A region from the midpoint to the last in L2 in Zone 3 and regions from the midpoint in L0 up to some midpoint in L2 in Zone 2 are determined as the use regions.

(S2212) The priority determination section 202 determines the starting physical address and ending physical address of each use region determined. Also, the priority determination section 202 determines the priorities, i.e., the use order, of the use regions secured so that recording proceeds in the order of inner periphery of L0→outer periphery of L0→outer periphery of L1→inner periphery of L1→inner periphery of L2→outer periphery of L2. The priority determination section 202 then stores the physical start and end addresses of the use regions and the use order of the use regions in the memory 107 as the conversion information used when the logical address to be accessed is converted to a physical address.

In FIG. 17, the entire data recording start address and the entire data recording end address are respectively at 902 and 901. In FIG. 18, the entire data recording start address and the entire data recording end address are respectively at 1002 and 1001. In FIG. 19, the entire data recording start address and the entire data recording end address are respectively at 1104 and 1103, and a seek is performed from 1101 to 1102.

The other configuration and operation of the optical disc recording system of this embodiment are the same as those of the first embodiment, and thus detailed description thereof is omitted here.

According to this embodiment, since a divided zone high in linear velocity is used preferentially for recording of the data to be recorded, the total recording time is shortened.

Also, since the data to be recorded is recorded on an outer portion of the disc, the number of revolutions of the spindle motor is reduced, permitting reduction in power consumption and also reduction in access time to the recorded data when the data is reproduced in the CAV control mode or the ZCLV control mode.

In general, the farther the recording layer as the recording target from the optical pickup 103, the worse the recording quality tends to become: e.g., the recording state varies depending on whether a recording layer existing between the target recording layer and the optical pickup 103 is already-recorded or non-recorded. In this embodiment, in which a recording layer closer to the optical pickup 103 is used more preferentially for recording of the data to be recorded within one divided zone, the possibility that the data to be recorded might be recorded with low quality in a recording layer farther from the optical pickup 103 is low.

### Variations of Second Embodiment

In the second embodiment described above, although the optical disc 101 on which data is to be recorded adopts the opposite track path scheme, it may adopt a parallel track path scheme. In this case, in (S2212), the use order may be determined so that recording proceeds in the order of inner periphery of L0→outer periphery of L0→inner periphery of L1→outer periphery of L1→inner periphery of L2→outer periphery of L2, for example.

In the second embodiment, the data zone has three divided zones different in recording/reproduction velocity. Alternatively, the number of divided zones included in the data zone may be two or four or more.

In the second embodiment, the divided zones are arranged in the data zone of the optical disc 101 so that the linear velocity is higher as the position is closer to the outermost periphery. The effect of shortening the total recording time can also be obtained by another way of arrangement of divided zones if only the divided zones are determined as use regions in order of decreasing linear velocity.

In the second embodiment, use regions are determined in the use order of inner periphery of L0→outer periphery of L0→outer periphery of L1→inner periphery of L1→inner periphery of L2→outer periphery of L2 in (S2212). The order is not limited to this as long as proper scanning is ensured in the data zone.

In the second embodiment, although recordable regions are determined as use regions in the order of L0, L1, and L2 within one divided zone in (S2211), the order is not limited to this. Also, arrangement may be made so that, before the recordable regions in all the recording layers in one divided zone have been determined as use regions, a recordable region in another divided zone may be determined as a use region.

In the second embodiment, the functions of the control device 214 are implemented by a plurality of processing sections. The configuration for implanting the functions is not limited to this, but the functions may be implemented by one-chip LSI, for example.

### Third Embodiment

In an optical disc recording system of the third embodiment of the present invention, the host device 120 does not notify the optical disc recording/reproduction device 100 of the capacity of the data to be recorded. Also, the optical disc recording system of this embodiment performs processing of (S3211) to (S3213) shown in FIG. 21, in place of the processing of (S1211), (S2211), and (S2212) in the second embodiment, in recording of the data to be recorded on the optical disc 101 in the CAV control mode.

(S3211) The region division section 201 divides the data zone in the radial direction into two divided zones as divided regions.

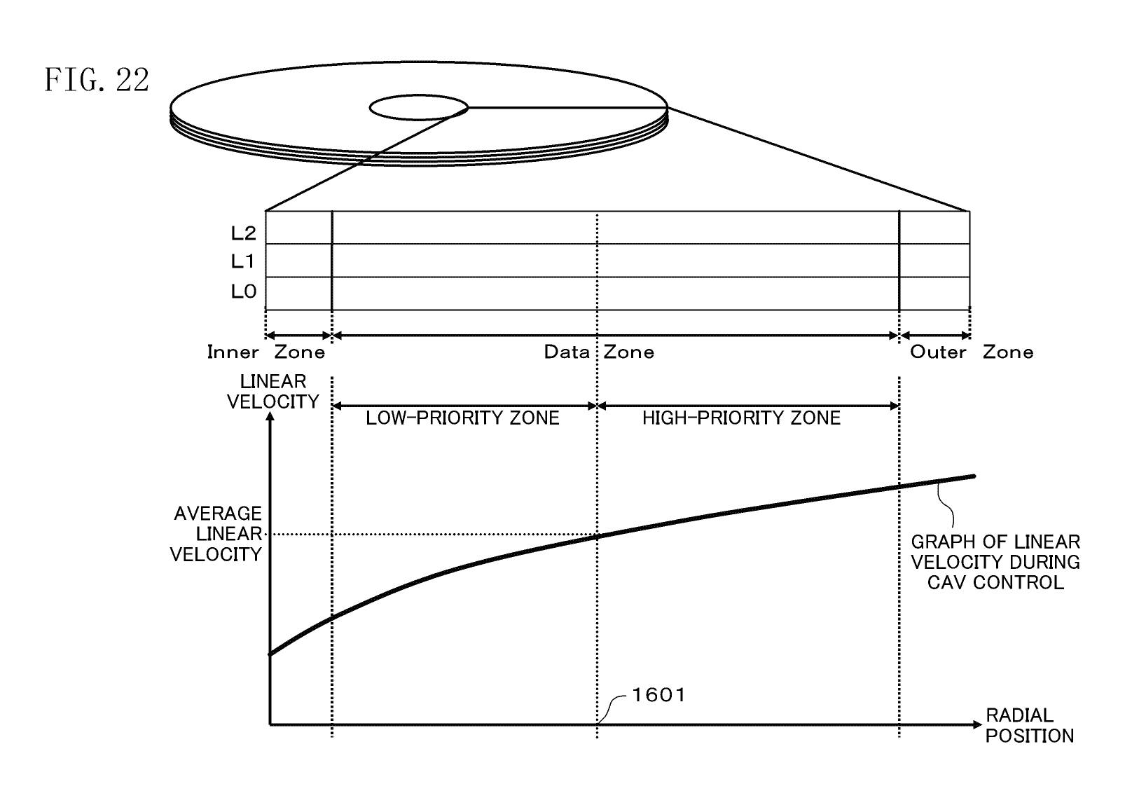

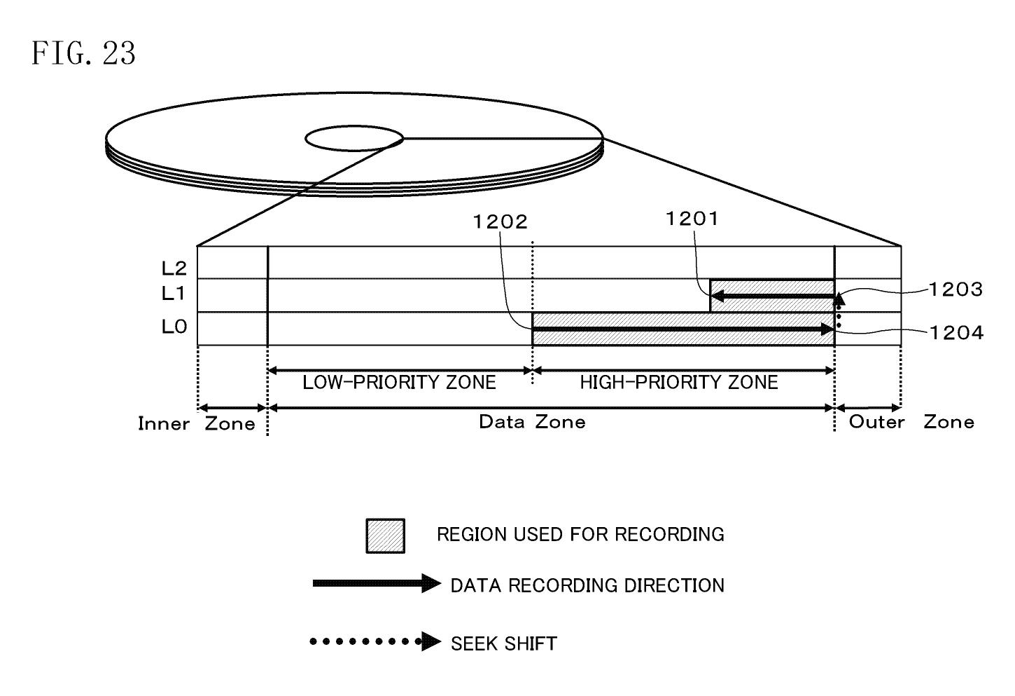

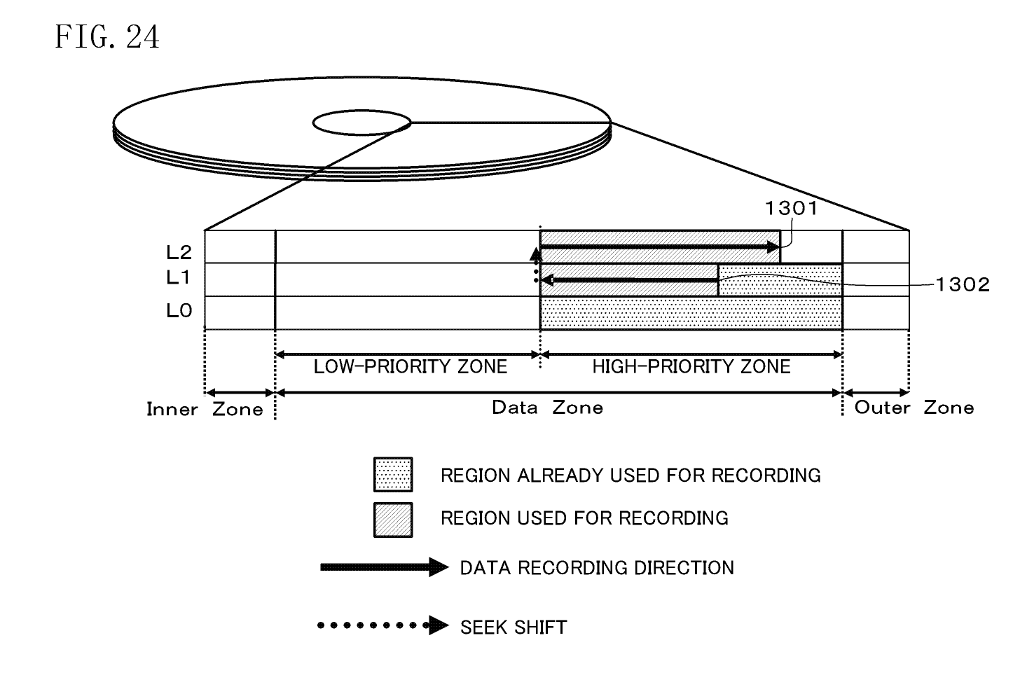

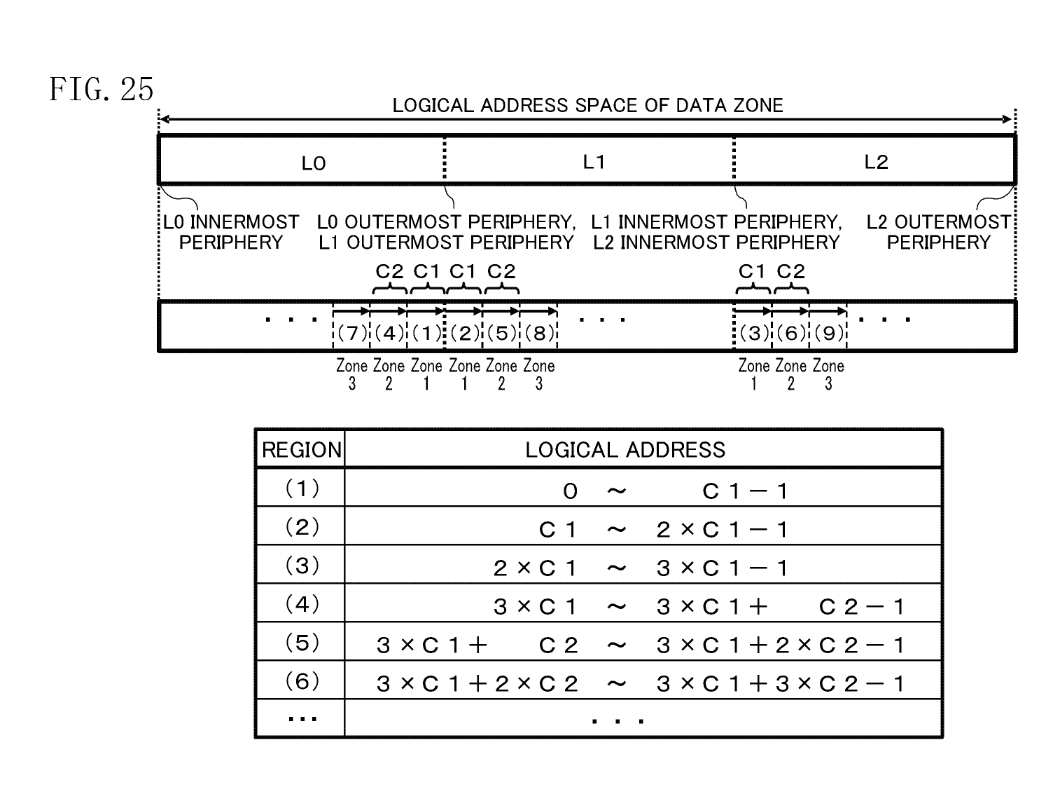

FIG. 22 shows an example of divided regions determined in the data zone of the optical disc 101. The data zone is divided into two divided zones, a low-priority zone and a high-priority zone, using a radial position at which the linear velocity in the CAV control mode is equal to the average linear velocity of the entire data zone as the division point. The radial position of the division point is denoted by 1601 in FIG. 22. The start addresses in the layers L0, L1, and L2 in the high-priority zone are stored in the memory 107. Note that, in FIGS. 23 and 24, also, the data zone is divided into the low-priority zone and the high-priority zone as in FIG. 22.

(S3212) The priority determination section 202 determines the priorities of the divided zones so that a higher priority is given to an outer divided zone than to an inner divided zone. In the example of FIG. 22, a higher priority is given to the high-priority zone than to the low-priority zone. That is, the priority determination section 202 determines the priorities so that the priority of a divided zone higher in linear velocity is higher than that of a divided zone lower in linear velocity.

The priority determination section 202 then reads the recordable region determination information from the memory 107, and also determines the use order of the plurality of divided zones. The use order is determined so that a divided zone higher in priority is used earlier, and, for divided zones equal in priority, a divided zone in a recording layer closer to the back surface is used earlier.

In FIG. 22, the use order is determined so that the high-priority zone is used prior to the low-priority zone. Also, within the same divided zone, the use order is determined in the order of L0, L1, and L2. That is, the use order is in the order of L0, L1, and L2 in the high-priority zone and L0, L1, and L2 in the low-priority zone.

FIG. 23 shows an example of the use order of divided zones of the optical disc 101 in its non-recorded state. In the illustrated use order, the first is the high-priority zone of L0, the second is the high-priority zone of L1, the third is the high-priority zone of L2, the fourth is the low-priority zone of L0, the fifth is the low-priority zone of L1, and the sixth is the low-priority zone of L2.

FIG. 24 shows an example of the use order of divided zones in the case of addition of data to be recorded to the optical disc 101 on which recording has been performed in the use regions in FIG. 23, where L0 in the high-priority zone has already been used. In this use order, the first is the high-priority zone of L1, the second is the high-priority zone of L2, the third is the low-priority zone of L0, the fourth is the low-priority zone of L1, and the fifth is the low-priority zone of L2.

(S3213) The address conversion section 112 determines the starting physical addresses and ending physical addresses of recordable regions included in the divided zones of which the use order has been determined in (S3212). In the subsequent processing, the starting physical addresses and ending physical addresses of the recordable regions in the divided zones and the use order of the recordable regions (use order of the divided zones) are respectively used as the starting physical addresses and ending physical addresses of the use regions and the use order of the use regions in the second embodiment.

The address conversion section 112 sets the starting physical address of a first-used recordable region as the starting physical address to be recorded, and the starting physical address to be recorded and the start and end addresses of the recordable regions are stored in the memory 107 as the conversion information used for conversion of the logical address to be accessed to a physical address.

Thereafter, the address conversion section 112 reads the logical address to be accessed (starting logical address) transmitted from the host device 120 from the memory 107, and converts the logical address to be accessed to the starting physical address of the first-used recordable region, i.e., the starting physical address to be recorded.

The data to be recorded is then recorded according to the use order determined in (S3212). In the examples of FIGS. 23 and 24, one divided zone for each recording layer used for recording of the data to be recorded is used for the recording.

In (S1205), since the capacity of the data to be recorded is not stored in the memory 107 of the optical disc recording/reproduction device 100, the system controller 108 determines whether to terminate the data recording by checking notification on data recording from the host device 120. The process proceeds to (S1206) if data recording is not terminated, or to (S1207) if it is terminated.

The other processing is similar to that of the optical disc recording system of the second embodiment in the ZCLV control mode, and thus detailed description thereof is omitted here.

The other configuration and operation of this embodiment are the same as those of the second embodiment, and thus detailed description thereof is omitted here.

In this embodiment, since a divided zone high in linear velocity is used preferentially for recording of the data to be recorded, the total recording time is shortened.

Also, since the data to be recorded is recorded on an outer portion of the optical disc 101, the number of revolutions of the spindle motor is reduced, permitting reduction in power consumption and also reduction in access time to the recorded data when the data is reproduced in the CAV control mode or the ZCLV control mode.

Moreover, as in the second embodiment, the possibility that the data to be recorded might be recorded in a hard-to-reproduce state in a recording layer farther from the optical pickup 103 is low.

### First Variation of Third Embodiment

In the third embodiment, the region division section 201 divides the data zone into two parts using a radial position at which the linear velocity is equal to the average linear velocity of the entire data zone as the division point. The division method is not limited to this.

In this variation, as shown in FIG. 25, an outer portion of the data zone of the optical disc 101 is divided into divided zones, Zone 1, Zone 2, Zone 3, . . . from outer to inner. In this case, recording is performed in the order indicated by the parenthesized numbers in FIG. 25, i.e., in the order of Zone 1 of L0, Zone 1 of L1, Zone 1 of L2, Zone 2 of L0, Zone 2 of L1, Zone 2 of L2, Zone 3 of L0, Zone 3 of L1, Zone 3 of L2, . . . . The logical addresses are as shown in the lower table of FIG. 25.

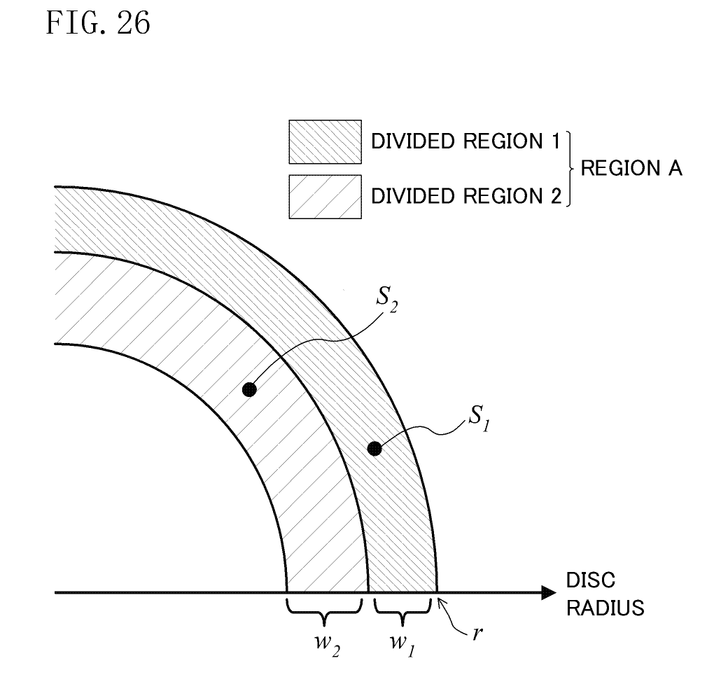

Assume herein that a given region A in the data zone is divided in the radial direction into divided regions 1 and 2 having the same area as shown in FIG. 26. Note that FIG. 26 shows a region of one quarter of the optical disc 101.

The area S₁ of the divided region 1 and the area S₂ of the divided region 2 are respectively expressed by

S₁=π{r²−(r−w₁)²} (1)

S₂=π{(r−w₁)²−(r−w₁−w₂)²} (2)

where w₁ is the width of the divided region 1 in the radial direction, w₂ is the width of the divided region 2 in the radial direction, and r is the radial position of the outer edge of the divided region 1 (distance from the center of the optical disc 101).

From Expressions (1) and (2) above, w₂ is expressed by

w₂=r−w₁−\sqrt{r²−4r·w₁+2w₁²} (3)

The condition under which the total recording time required when the data to be recorded is recorded in the divided region 1 of two recording layers is equal to or less than the total recording time required when the data to be recorded is recorded in the region A (the divided regions 1 and 2) of one recording layer is expressed by

$$\frac{{w}_{2} - {w}_{1}}{v} \geq {t}_{m} \qquad ( 4 )$$

where v is the scanning velocity of the optical pickup 103 in the radial direction, and tₘ is the time required when a shift between two recording layers is involved.

By substituting Expression (3) in Expression (4), Expression (5) below is derived.

$${w}_{1} \geq \sqrt{\frac{1}{2} {v}^{2} \cdot {t}_{m}^{2} + r \cdot v \cdot {t}_{m}} - v \cdot {t}_{m} \qquad ( 5 )$$

In this variation, the region division section 201 sets the width w₁′ of each divided zone sequentially from outer to inner of the data zone so that the width w₁′ of the divided zone in question and the width w₂′ of its inwardly-adjacent region having the same area as the divided zone in question satisfy Expression (6) below. From Expression (4) above, if the value of t in Expression (6) below is larger than tₘ, the effect of shortening the total recording time can be obtained by the division.

$$\frac{{w}_{2}^{′} - {w}_{1}^{′}}{v} = t \qquad ( 6 )$$

For example, when v is 0.0575 [mm/s], the radial position of the outermost periphery of the data zone is 58.5 [mm], and t in Expression (6) is 1 [s], the region division section 201 divides the data zone of the optical disc 101 into Zone 1 to Zone 24 shown in Table 1 below. Table 1 shows the width of each zone and the radial position of the inner edge of the zone. For example, Zone 1 is a doughnut-shaped region having a width of 1.777 [mm] and a distance of its inner edge from the disc center of 56.723 [mm].

TABLE 1

| | | |
|---|---|---|
| Head scanning velocity (v) | 0.0575 | [mm/s] |
| Advantage time (tm) | 1 | [s] |
| Outermost position | 58.5 | [mm] |

| Zone | Width [mm] | Start position [mm] |
|---|---|---|
| 1 | 1.777 | 56.723 |
| 2 | 1.749 | 54.974 |
| 3 | 1.721 | 53.253 |
| 4 | 1.693 | 51.560 |
| 5 | 1.665 | 49.896 |
| 6 | 1.637 | 48.259 |
| 7 | 1.609 | 46.650 |
| 8 | 1.581 | 45.069 |
| 9 | 1.553 | 43.516 |
| 10 | 1.525 | 41.991 |
| 11 | 1.497 | 40.495 |
| 12 | 1.469 | 39.026 |
| 13 | 1.441 | 37.585 |
| 14 | 1.413 | 36.171 |
| 15 | 1.385 | 34.786 |
| 16 | 1.357 | 33.429 |
| 17 | 1.330 | 32.099 |
| 18 | 1.302 | 30.798 |
| 19 | 1.274 | 29.524 |
| 20 | 1.246 | 28.278 |
| 21 | 1.218 | 27.059 |
| 22 | 1.191 | 25.869 |
| 23 | 1.163 | 24.706 |
| 24 | 1.135 | 23.571 |

From Expression (5) above, the width of Zone 1 can be computed by substituting values of v, t, and r in Expression (7) below.

$${w}_{1}^{′} = \sqrt{\frac{1}{2} {v}^{2} \cdot {t}^{2} + r \cdot v \cdot t} - v \cdot t \qquad ( 7 )$$

When t is set at 2 [s], the region division section 201 divides the data zone of the optical disc 101 into Zone 1 to Zone 17 shown in Table 2 below.

TABLE 2

| | | |
|---|---|---|
| Head scanning velocity (v) | 0.0575 | [mm/s] |
| Advantage time (tm) | 2 | [s] |
| Outermost position | 58.5 | [mm] |

| Zone | Width [mm] | Start position [mm] |
|---|---|---|
| 1 | 2.480 | 56.020 |
| 2 | 2.424 | 53.596 |
| 3 | 2.369 | 51.227 |
| 4 | 2.314 | 48.913 |
| 5 | 2.258 | 46.655 |
| 6 | 2.203 | 44.452 |
| 7 | 2.147 | 42.305 |
| 8 | 2.092 | 40.213 |
| 9 | 2.037 | 38.176 |
| 10 | 1.982 | 36.194 |
| 11 | 1.927 | 34.267 |
| 12 | 1.872 | 32.395 |
| 13 | 1.817 | 30.578 |
| 14 | 1.762 | 28.816 |
| 15 | 1.707 | 27.109 |
| 16 | 1.653 | 25.457 |
| 17 | 1.598 | 23.859 |

When v is set at 0.115 [mm/s], the radial position of the outermost periphery of the data zone is set at 58.5 [mm], and t is set at 2 [s], the region division section 201 divides the data zone of the optical disc 101 into Zone 1 to Zone 13 shown in Table 3 below.

TABLE 3

| | | |
|---|---|---|
| Head scanning velocity (v) | 0.115 | [mm/s] |
| Advantage time (tm) | 2 | [s] |
| Outermost position | 58.5 | [mm] |

| Zone | Width [mm] | Start position [mm] |
|---|---|---|
| 1 | 3.442 | 55.058 |
| 2 | 3.332 | 51.726 |
| 3 | 3.223 | 48.503 |
| 4 | 3.114 | 45.389 |
| 5 | 3.005 | 42.384 |
| 6 | 2.896 | 39.487 |
| 7 | 2.788 | 36.699 |
| 8 | 2.680 | 34.020 |
| 9 | 2.572 | 31.448 |
| 10 | 2.464 | 28.983 |
| 11 | 2.357 | 26.626 |
| 12 | 2.250 | 24.376 |
| 13 | 2.143 | 22.233 |

As shown in Tables 1 to 3 above, in the division method of this variation, the widths of the divided zones in the radial direction gradually decrease from outer to inner divided zones.

By using the method of this variation for the determination of divided regions in (S3211), the effect of shortening the recording time can be obtained without fail.

The method of this variation may be used for determination of divided regions, not only for the case that the all regions of the optical disc are subjected to recording in the CAV control mode, but also for the case that, while some regions of the optical disc are subjected to recording in a control mode other than CAV, the remaining regions are subjected to recording in the CAV control mode, in which case, though, the method is applicable to only the regions subjected to recording in the CAV control mode.

### Other Variations of Third Embodiment

In the third embodiment, the priority determination section 202 determines the priority of each divided zone based on the radial position of the divided zone, i.e., the linear velocity of the divided zone. Alternatively, the priority may be determined based on the capacity of the recordable region in each divided zone.

Also, although the data zone is divided into two divided zones in the third embodiment, it may be divided into three or more divided zones.

A higher priority does not have to be given to a divided zone located closer to the outermost periphery. For example, the priority of a divided zone that does not include the outermost periphery of the data zone may be made higher than that of a divided zone that includes the outermost periphery. In many optical discs, a divided zone including the outermost periphery has a higher possibility of failing in recording than an inner divided zone. This is because an outer portion of an optical disc is generally susceptible to warpage and distortion of the optical disc, and moreover, if the optical disc has a recording layer formed by application of a dye, the dye tends to be uneven in an outer portion. When such an optical disc is subjected to recording, a divided zone that does not include the outermost periphery may be used preferentially as described above, to improve the recording precision. There is also a problem that, in the case of switching the rotation control mode from one to another during recording, it will take time to perform this switching, resulting in increase in total recording time. If the position at which the rotation control mode changes is included in a divided zone including the outermost periphery, the necessity of switching of the rotation control mode during recording will be less likely to occur by using a divided zone that does not include the outermost periphery preferentially.

Also, considering both the linear velocity and the recording precision, a higher priority may be given to a divided zone including neither the outermost periphery nor the innermost periphery of the data zone than to a divided zone including the outermost periphery and a divided zone including the innermost periphery.

In the third embodiment described above, although the optical disc 101 on which data is to be recorded adopts the opposite track path scheme, it may adopt a parallel track path scheme.

In the third embodiment, recording in the CAV control mode was described. In the case of recording in other spindle motor control modes, such as a CLV control mode, the ZCLV control mode, and a ZCAV control mode, also, the priorities of the divided regions may be determined based on the characteristics of the divided regions.

In the third embodiment, the use order is determined so that the recording layers are used in the order of L0, L1, and L2 in divided zones equal in priority in (S3212). The use order is not limited to this. For example, the use order may be set according to the magnitude of the transfer rate required for the data to be recorded. Otherwise, the use order may be set based on the track scanning direction to ensure the short seek time.

### Fourth Embodiment

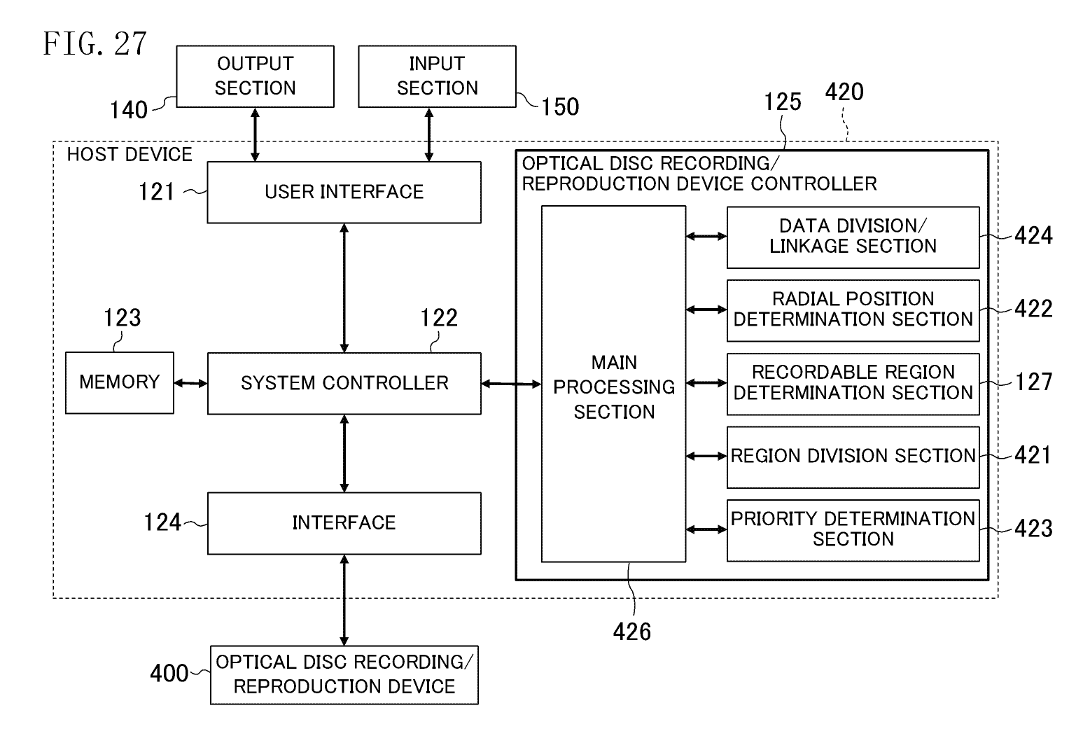

An optical disc recording system of the fourth embodiment of the present invention includes a host device 420 shown in FIG. 27 in place of the host device 120 in the first embodiment. As shown in FIG. 27, the host device 420 includes a region division section 421, a radial position determination section 422, a priority determination section 423, and a data division/linkage section 424, in addition to the components of the host device 120 in the first embodiment. The host device 420 also includes a main processing (linkage information reception section) 426 in place of the main processing section 126 in the first embodiment.

The region division section 421 divides a recordable region in the data zone of the optical disc 101 into a use region where data is recorded and a non-use region where data is not recorded. In other words, the region division section 421 determines a use region used for data recording.

The radial position determination section 422 determines a radial position on the optical disc 101 corresponding to the logical address to be accessed based on the optical disc management information.

The priority determination section 423 determines use priorities of the use region determined by the region division section 421.

The data division/linkage section 424 divides the data to be recorded on the optical disc 101 and also links divided data units read from the optical disc 101.

The optical disc recording system of the fourth embodiment also includes an optical disc recording/reproduction device 400 in place of the optical disc recording/reproduction device 100. In the optical disc recording/reproduction device 400, in comparison with the optical disc recording/reproduction device 100 of FIG. 2, neither the data division section 110 nor the recording time computation section 111 are included. The address conversion section 112 converts the logical address to be accessed received from the host device 420 via the system controller 108 to a physical address according to the correspondence as shown in FIG. 5, as conventionally done. For example, when the logical address starts at 0, the logical address 0 is converted to the physical address at the innermost periphery of L0.

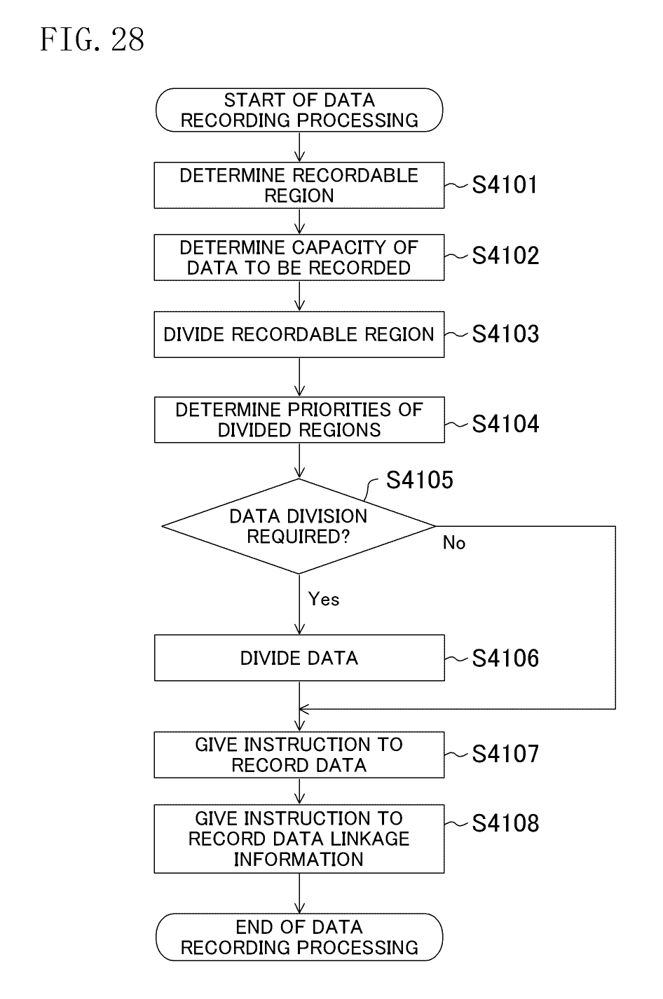

If the operation instruction from the user is a recording instruction, the host device 420 of this embodiment performs, in (S1004) in FIG. 6, the operation shown in the flowchart of FIG. 28 in place of the processing shown in FIGS. 7 and 8. The operation shown in the flowchart of FIG. 28 will be described hereinafter.

(S4101) The main processing section 426 receives the optical disc management information from the memory 123, and the recordable region determination section 127 determines a recordable region based on the optical disc management information received via the main processing section 426.

(S4102) The system controller 122 determines the capacity of the data to be recorded under the instruction from the user, and sends the capacity to the main processing section 426.

(S4103) The region division section 421 divides the recordable region into a use region used for recording of the data to be recorded and a non-use region that is not used for recording of the data to be recorded, according to an instruction from the main processing section 426. In other words, the region division section 421 determines a use region from the recordable region. The division is performed so that the capacity of the use region is the sum of the capacity of the data to be recorded and the capacity of data linkage information. As the use region, determined is a region that includes an outermost portion of the recordable region of which the radial position has been determined by the radial position determination section 422 and does not include an innermost portion of the recordable region.

The data linkage information as used herein is information necessary for the host device 420 to recognize separately-recorded data units as one data track. In the fourth embodiment, the start addresses and capacities of divided data units, the order of linkage of the divided data units, and a discrimination code are recorded in a region immediately preceding the data to be recorded. The discrimination code, which is a code for discriminating the data to be recorded from the data linkage information, is referred to by the host device 420 when data recorded on the optical disc 101 is reproduced.

(S4104) The priority determination section 423 determines use priorities of divided regions of the use region used for recording. The use priority is determined to be higher as the starting logical address is smaller. Information on the use region (the number of divided regions, the starting and ending logical addresses and use priorities of the divided regions) is stored in the memory 123.

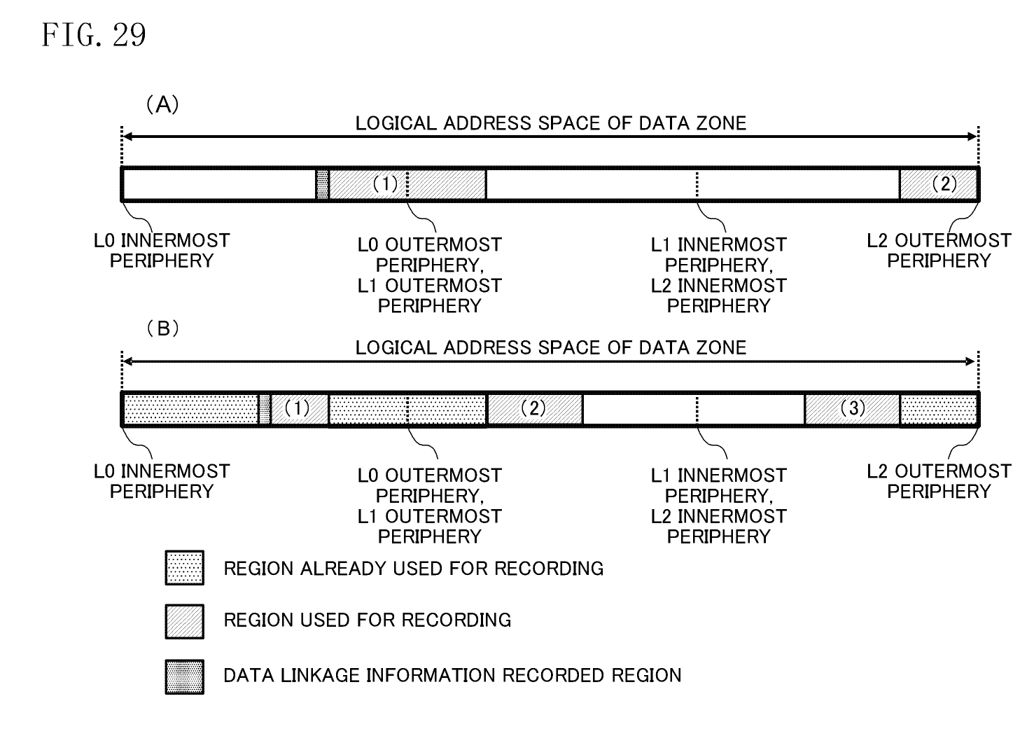

FIGS. 29A and 29B each show the use region determined in the logical address space and use priorities of divided regions constituting the use region. FIG. 29A represents recording of the data to be recorded on the optical disc 101 in its non-recorded state, showing the use region and use priorities of divided regions constituting the use region, where the use priorities are in the order of (1) and (2). FIG. 29B represents addition of data to the optical disc 101 on which some data has already been recorded, showing the use region and use priorities of divided regions constituting the use region, where the use priorities are in the order of (1), (2), and (3).

(S4105) The main processing section 426 reads the information on the use region from the memory 123, checks whether or not the use region has been divided. If the use region has been divided, the main processing section 426 determines that the data to be recorded must be divided, and the process proceeds to (S4106). If the use region has not been divided, the main processing section 426 determines that no division of the data to be recorded is necessary, and the process proceeds to (S4107).

(S4106) The data division/linkage section 424 divides the data to be recorded according to the sizes of the divided regions constituting the use region. Divided data units and information on the data units (the recording order and the capacities) are stored in the memory 123. In FIG. 29A, in which the use region is divided into two divided regions, the data to be recorded is divided into two parts according to the sizes of the divided regions. FIG. 29B, in which the use region is divided into three divided regions, the data to be recorded is divided into three parts according to the sizes of the divided regions.

(S4107) The system controller 122 receives data recording information (data to be recorded on the optical disc 101 and the logical address for recording on the optical disc) from the main processing section 426, and transmits the data recording information to the optical disc recording/reproduction device 400 together with an instruction for data recording. If data division has been performed in (S4106), this instruction is made to ensure that a plurality of divided regions of the use region are used for the recording sequentially in order of decreasing use priority. In FIG. 29A, the instruction is made to use the divided regions in the order of (1) and (2), and in FIG. 29B, the instruction is made to use the divided regions in the order of (1), (2), and (3).

(S4108) Once receiving an acknowledgement of completion of the data recording from the optical disc recording/reproduction device 400, the system controller 122 instructs the optical disc recording/reproduction device 400 to record the data linkage information. The data linkage information is then recorded in a region immediately preceding the use region (data to be recorded). FIGS. 29A and 29B show the region for recording the data linkage information.

In this embodiment, when the operation instruction from the user is a reproduction instruction and data to be reproduced has been recorded in a plurality of divided regions separately, the optical disc recording/reproduction device 400 reads the data linkage information from the optical disc 101 as information indicating the reproduction order of the divided regions in (S1001) in FIG. 6, in addition to the operation described in the first embodiment. In the host device 420, the main processing section 426 receives the data linkage information from the optical disc recording/reproduction device 400, and the data division/linkage section 424 links the divided data units together in the linkage order based on the data linkage information received via the main processing section 426, to obtain one data track. In (S1302) in FIG. 12, the main processing section 426 instructs the optical disc recording/reproduction device 400 of data reproduction of the divided data units according to the reproduction order indicated in the data linkage information.

According to this embodiment, when the CAV control mode is adopted, the data to be recorded is recorded on an outer portion of the optical disc 101, i.e., in a region high in linear velocity, whereby the recording time is shortened. Also, the reproduction time required for reproduction of the recorded data is shortened.

When the CLV control mode is adopted, the number of revolutions of the spindle motor during recording of the data to be recorded and during reproduction of the recorded data is reduced, permitting reduction in power consumption and also reduction in running noise of the spindle motor.

### Variations of Fourth Embodiment

In the fourth embodiment, a region that includes an outermost portion of the recordable region and does not include an innermost portion of the recordable region is determined as the use region. Determination of the use region is not limited to this, but it is only necessary to determine the use region so that the recording/reproduction time or the number of revolutions of the spindle motor becomes a desired value.

In the fourth embodiment, the data linkage information includes the start addresses and capacities of the divided data units, the linkage order of the divided data units, and the discrimination code. The format of the data linkage information is not limited to this, but any other format may be used as long as the data recorded as divided data units can be reproduced as one data track by referring to the data linkage information.

In the fourth embodiment, the data linkage information is recorded in a region immediately preceding the use region, but the recording position of the data linkage information is not limited to this. Also, the data linkage information is not necessarily separated from the divided data, but may be information incorporated in the divided data itself.

### Other Variations

In the first to third embodiments, the linkage information recorded in (S1222) has a format of the starting physical addresses and data sizes of the use regions listed in order of use. The format of the data linkage information is not limited to this, but any other format may be used as long as the data recorded as divided data units can be reproduced as one data track by referring to the linkage information.

In the first to third embodiments, the configurations of the optical disc recording/reproduction devices 100 and 200 are not limited to those shown in FIGS. 2 and 15, respectively, but other configurations may be used as long as the functions of the components of the optical disc recording/reproduction devices 100 and 200 are implemented.

In the first to fourth embodiments, the configurations of the host devices 120 and 420 are not limited to those shown in FIGS. 4 and 27, respectively, but other configurations may be used as long as the functions of the components of the host devices 120 and 420 are implemented.

In the first to fourth embodiments, the configuration of the optical disc 101 is not limited to that shown in FIGS. 3, 5, etc. For example, the number of recording layers of the optical disc 101 is not limited to three, but may be any number equal to or more than two.

The optical disc recording method, the optical disc recording device control method, the optical disc recording device, the host device, the optical disc recording control program, and the optical disc recording device control program of the present invention are useful as techniques, etc. of allocating data to be recorded on an optical disc.

What is claimed is:

1. An optical disc recording method for recording data to be recorded on an optical disc having a plurality of recording layers at a recording velocity depending on a radial position, the method comprising the step of:
selecting a use pattern in which given recordable regions included in a data zone of the optical disc are used for recording of the data to be recorded in given use order, among a plurality of use patterns different in the number of recording layers used, so that the total recording time is shortened, based on given conditions including at least the capacity of the data to be recorded, the recording velocities of use regions in the use pattern, and the number of interlayer shifts in the use pattern,
wherein
the data to be recorded is recorded according to the use pattern selected in the use pattern selection step.

2. The optical disc recording method of claim 1, wherein
the use pattern selection step includes
performing a selection operation of selecting one of a first use pattern of using n (n is a natural number) recording layer(s) and a second use pattern of using (n+1) recording layers based on the given conditions,
starting repetition operation of repeating the selection operation by incrementing n by one at a time from 1 until n=m−1 when the number of recording layers of the optical disc, represented by m, is 3 or more, and
while, if the second use pattern is selected in every selection operation during the repetition operation, selecting a use pattern using m recording layers,
if the first use pattern is selected in a given selection operation during the repetition operation, selecting the first use pattern in this selection operation that has first selected the first use pattern.

3. The optical disc recording method of claim 1, wherein
when recording is performed in a CAV control mode for part or the entire of the optical disc, a recordable region used in the use pattern includes the outermost periphery of the recordable regions in the data zone of the optical disc and does not include a region located closer to the innermost periphery than a recordable region that is not used for recording of the data to be recorded in the use pattern.

4. The optical disc recording method of claim 1, wherein
the total recording time includes a seek time.

5. The optical disc recording method of claim 1, wherein
the total recording time includes a time for adjustment of a parameter used for recording.

6. The optical disc recording method of claim 1, wherein
an interlayer shift performed in the use pattern selected in the use pattern selection step is an interlayer shift to a recording layer opposite in the scanning direction to its immediately preceding recording layer.

7. The optical disc recording method of claim 1, wherein
linkage information indicating use regions used for recording of the data to be recorded and use order of the use regions is recorded on the optical disc.

8. The optical disc recording method of claim 1, further comprising the step of:
converting a starting logical address of the data to be recorded to a starting physical address of a recording position at which recording is first performed in the use pattern selected in the use pattern selection step,
wherein
recording of the data to be recorded is started at the recording position indicated by the starting physical address obtained in the address conversion step.

9. The optical disc recording method of claim 1, wherein
when no data has been recorded in the data zone of the optical disc, regions having the same capacity are used for recording of the data to be recorded in the recording layers used for recording of the data to be recorded.

10. The optical disc recording method of claim 1, further comprising the step of:
determining recordable regions in the recording layers of the optical disc based on information read from the optical disc,
wherein
when data has already been recorded in the data zone of the optical disc, a portion of the data to be recorded having a capacity corresponding to the capacity of the recordable region in each of the recording layers determined in the recordable region determination step is recorded in the recording layer.

11. The optical disc recording method of claim 1, wherein
when data has already been recorded in the data zone of the optical disc, the data to be recorded is recorded in a region in which no data has been recorded.

12. An optical disc recording method for recording data to be recorded on an optical disc having at least one recording layer, the method comprising the steps of:
dividing a data zone of each recording layer of the optical disc in a radial direction to determine a plurality of divided regions; and
determining a priority of each of the divided regions determined in the region division step based on a characteristic of the divided region,
wherein
the divided regions are used for recording of the data to be recorded in decreasing order of the priority determined in the priority determination step.

13. The optical disc recording method of claim 12, wherein
the characteristic of the divided region is the linear velocity of the divided region.

14. The optical disc recording method of claim 12, further comprising the step of:
determining a recordable region in the data zone of the optical disc based on information read from the optical disc,
wherein
the characteristic of the divided region is the capacity of a recordable region in the divided region.

15. The optical disc recording method of claim 12, wherein
the data to be recorded is recorded on the optical disc having a plurality of recording layers using a plurality of recording layers.

16. The optical disc recording method of claim 15, wherein
when a plurality of divided regions having the same priority exist in a plurality of recording layers, the priority determination step determines the use order of the plurality of divided regions based on to which recording layer, among the plurality of recording layers, each of the divided regions belongs.

17. The optical disc recording method of claim 15, wherein
when a plurality of divided regions having the same priority exist in a plurality of recording layers, the priority determination step determines the use order of the plurality of divided regions based on the track scanning direction of a recording layer to which each of the divided regions belongs.

18. The optical disc recording method of claim 15, wherein
the priority determination step determines the priority so that a higher priority is given to a region closer to the outermost periphery.

19. The optical disc recording method of claim 18, wherein
when the data to be recorded is recorded on part or the entire of the optical disc having a plurality of recording layers in a CAV control mode, the region division step determines the width of each of the divided regions sequentially from outer to inner regions, so that the time obtained by dividing the difference between a width w1 of the divided zone in question and a width w2 of its inwardly-adjacent region that has the same area as the divided zone in question by the scanning velocity of a pickup in a radial direction is longer than the time required for a shift between recording layers.

20. The optical disc recording method of claim 18, wherein
when the data to be recorded is recorded on part or the entire of the optical disc having a plurality of recording layers in a CAV control mode, the region division step determines the divided regions so that the widths of the divided regions in a radial direction gradually decrease as the divided regions are closer to the innermost periphery.

21. The optical disc recording method of claim 12, wherein
the priority determination step gives a higher priority to a divided region including neither the outermost periphery nor innermost periphery of the data zone than to a divided region including the outermost periphery and a divided region including the innermost periphery.

22. The optical disc recording method of claim 21, wherein
a divided region including the outermost periphery has a higher possibility of failing in recording than a divided region including neither the outermost periphery nor the innermost periphery.

23. The optical disc recording method of claim 21, wherein
a divided region including the outermost periphery includes a position at which the rotation control mode changes.

24. The optical disc recording method of claim 21, wherein
the data to be recorded is recorded on the optical disc having a plurality of recording layers using a plurality of recording layers.

25. The optical disc recording method of claim 24, wherein
one divided region for each of the recording layers used for recording of the data to be recorded is used for recording of the data to be recorded.

26. The optical disc recording method of claim 12, further comprising the step of:
converting a starting logical address of the data to be recorded to a starting physical address of a divided region having a priority highest among the priorities of the divided regions determined in the priority determination step,
wherein
recording of the data to be recorded is started at a recording position indicated by the starting physical address obtained by the conversion in the address conversion step.

27. The optical disc recording method of claim 12, wherein
when data has already been recorded in the data zone of the optical disc, the data to be recorded is recorded in a region in which no data has been recorded.

28. An optical disc recording device control method executed by a host device that transmits data to be recorded, of which recording instruction has been given by the user, to an optical disc recording device, the method comprising the steps of:
determining the capacity of the data to be recorded; and
notifying the optical disc recording device of the capacity of the data to be recorded determined in the capacity determination step.

29. An optical disc recording device control method executed by a host device that transmits data to be recorded, of which recording instruction has been given by the user, to an optical disc recording device that records data on part or the entire of an optical disc in a CAV control mode, the method comprising the steps of:
determining a recordable region in a data zone of the optical disc based on information read from the optical disc by the optical disc recording device; and
determining a region including no innermost periphery, as a use region, from the recordable region determined in the recordable region determination step,
wherein
the host device instructs the optical disc recording device to record the data to be recorded in the use region determined in the use region determination step.

30. The optical disc recording device control method of claim 29, further comprising the step of:
determining a use priority of each of divided regions constituting the use region determined in the use region determination step,
wherein
the host device instructs the optical disc recording device to use divided regions for recording of the data to be recorded in decreasing order of the use priority determined in the priority determination step.

31. An optical disc recording device control method executed by a host device that instructs an optical disc recording device to reproduce data in response to an instruction from the user, the method comprising the step of:
receiving data linkage information indicating reproduction order of divided regions from the optical disc recording device when the data to be reproduced has been divided and recorded in a plurality of divided regions,
wherein
the host device instructs the optical disc recording device to reproduce the data in the plurality of divided regions in the reproduction order indicated by the data linkage information received in the linkage information reception step.

32. An optical disc recording device configured to record data to be recorded on an optical disc having a plurality of recording layers at a recording velocity depending on a radial position, the device comprising:
a use pattern selection section configured to select a use pattern in which given recordable regions included in a data zone of the optical disc are used for recording of the data to be recorded in given use order, among a plurality of use patterns different in the number of recording layers used, so that the total recording time is shortened, based on given conditions including at least the capacity of the data to be recorded, the recording velocities of use regions in the use pattern, and the number of interlayer shifts in the use pattern,
wherein
the data to be recorded is recorded according to the use pattern selected by the use pattern selection section.

33. An optical disc recording device configured to record data to be recorded on an optical disc having at least one recording layer, the device comprising:
a region division section configured to divide a data zone of each recording layer of the optical disc in a radial direction to determine a plurality of divided regions; and
a priority determination section configured to determine a priority of each of the divided regions determined by the region division section based on a characteristic of the divided region,
wherein
the divided regions are used for recording of the data to be recorded in decreasing order of the priority determined by the priority determination section.

34. A host device configured to transmit data to be recorded, of which recording instruction has been given by the user, to an optical disc recording device, the host device comprising:
a capacity determination section configured to determine the capacity of the data to be recorded; and
a capacity notification section configured to notify the optical disc recording device of the capacity of the data to be recorded determined by the capacity determination section.

35. A host device configured to transmit data to be recorded, of which recording instruction has been given by the user, to an optical disc recording device that records data on part or the entire of optical disc in a CAV control mode, the host device comprising:
a recordable region determination section configured to determine a recordable region in a data zone of the optical disc based on information read from the optical disc by the optical disc recording device; and
a use region determination section configured to determine a region including no innermost periphery, as a use region, from the recordable region determined by the recordable region determination section,
wherein
the host device instructs the optical disc recording device to record the data to be recorded in the use region determined by the use region determination section.

36. A host device configured to instruct an optical disc recording device to reproduce data in response to an instruction from the user, the host device comprising:
a linkage information reception section configured to receive data linkage information indicating reproduction order of divided regions from the optical disc recording device when the data to be reproduced has been divided and recorded in a plurality of divided regions,
wherein
the host device instructs the optical disc recording device to reproduce the data in the plurality of divided regions in the reproduction order indicated by the data linkage information received by the linkage information reception section.

37. An optical disc recording control program to be executed, in an optical disc recording device, by a control device configured to control an optical pickup so that data to be recorded is recorded on an optical disc having a plurality of recording layers at a recording velocity depending on a radial position, the program allowing the control device to execute the steps of:
selecting a use pattern in which given recordable regions included in a data zone of the optical disc are used for recording of the data to be recorded in given use order, among a plurality of use patterns different in the number of recording layers used, so that the total recording time is shortened, based on given conditions including at least the capacity of the data to be recorded, the recording velocities of use regions in the use pattern, and the number of interlayer shifts in the use pattern; and
controlling the optical pickup so that the data to be recorded is recorded according to the use pattern selected in the use pattern selection step.

38. An optical disc recording control program to be executed, in an optical disc recording device, by a control device configured to control an optical pickup so that data to be recorded is recorded on an optical disc having at least one recording layer, the program allowing the control device to execute the steps of:
dividing a data zone of each recording layer of the optical disc in a radial direction to determine a plurality of divided regions;
determining a priority of each of the divided regions determined in the region division step based on a characteristic of the divided region; and
controlling the optical pickup so that divided regions are used for recording of the data to be recorded in decreasing order of the priority determined in the priority determination step.

39. An optical disc recording device control program to be executed by a host device that transmits data to be recorded, of which recording instruction has been given by the user, to an optical disc recording device, the program allowing the host device to execute the steps of:
determining the capacity of the data to be recorded; and
notifying the optical disc recording device of the capacity of the data to be recorded determined in the capacity determination step.

40. An optical disc recording device control program to be executed by a host device that transmits data to be recorded, of which recording instruction has been given by the user, to an optical disc recording device that records data on part or the entire of optical disc in a CAV control mode, the program allowing the host device to execute the steps of:
determining a recordable region in a data zone of the optical disc based on information read from the optical disc by the optical disc recording device;
determining a region including no innermost periphery, as a use region, from the recordable region determined in the recordable region determination step; and
instructing the optical disc recording device to record the data to be recorded in the use region determined in the use region determination step.

41. An optical disc recording device control program to be executed by a host device that instructs an optical disc recording device to reproduce data in response to an instruction from the user, the program allowing the host device to execute the steps of:
receiving data linkage information indicating reproduction order of divided regions from the optical disc recording device when the data to be reproduced has been divided and recorded in a plurality of divided regions; and
instructing the optical disc recording device to reproduce the data on the plurality of divided regions in the reproduction order indicated by the data linkage information received in the linkage information reception step.
